(19) United States
(12) Patent Application Publication
(10) Pub. No.: US 2018/0356572 A1
(43) Pub. Date: Dec. 13, 2018

(54) FAR INFRARED RAY TRANSMITTING COMPOSITION, FORMED BODY, LAMINATE, FAR INFRARED RAY TRANSMITTING FILTER, SOLID-STATE IMAGING DEVICE, AND INFRARED CAMERA

(71) Applicant: FUJIFILM Corporation, Tokyo (JP)

(72) Inventors: Hirotaka TAKISHITA, Haibara-gun (JP); Hidenori TAKAHASHI, Haibara-gun (JP); Kazuto SHIMADA, Haibara-gun (JP)

(73) Assignee: FUJIFILM Corporation, Tokyo (JP)

(21) Appl. No.: 16/106,452

(22) Filed: Aug. 21, 2018

Related U.S. Application Data
(63) Continuation of application No. PCT/JP2017/008419, filed on Mar. 3, 2017.

(30) Foreign Application Priority Data
Mar. 28, 2016 (JP) 2016-063033

(51) Int. Cl. G02B 5/20; G03B 11/00; C08L 33/10

(52) U.S. Cl. CPC G02B 5/208; G02B 1/115; C08L 33/10; G03B 11/00

(57) ABSTRACT

A far infrared ray transmitting composition includes a particle having a refractive index of 1.3 to 5.0 at a wavelength of 10 μm and a medium.

### CROSS-REFERENCE TO RELATED APPLICATIONS

This application is a Continuation of PCT International Application No. PCT/JP2017/008419, filed on Mar. 3, 2017, which claims priority under 35 U.S.C. § 119(a) to Japanese Patent Application No. 2016-63033, filed on Mar. 28, 2016. Each of the above application(s) is hereby expressly incorporated by reference, in its entirety, into the present application.

### BACKGROUND OF THE INVENTION

### 1. Field of the Invention

The present invention relates to a far infrared ray transmitting composition, a formed body, a laminate, a far infrared ray transmitting filter, a solid-state imaging device, and an infrared camera.

### 2. Description of the Related Art

In recent years, the development of optical devices and optical elements using far infrared rays has been advanced. Germanium (Ge), silicon (Si), and the like have been known as infrared transmitting materials used for these optical devices and optical elements. For example, JP2014-48109A describes that a lens formed of Ge, Si, or the like is used as a lens for condensing far infrared rays.

### SUMMARY OF THE INVENTION

In the related art, in the case of forming a lens with Ge or Si, an ingot of Ge or Si is cut to form a lens shape. However, since Ge and Si have high hardness, there is a problem that processing thereof requires efforts or time.

Accordingly, an object of the present invention is to provide a far infrared ray transmitting composition that can manufacture a formed body having far infrared ray transmitting properties by a method different from that in the related art, a formed body, a laminate, a far infrared ray transmitting filter, a solid-state imaging device, and an infrared camera.

According to the circumstances, the present inventors diligently conducted research to find that the object can be achieved by the following configurations, such that the present invention is completed. Accordingly, the present invention provides the following.

<1> A far infrared ray transmitting composition comprising: a particle having refractive index of 1.3 to 5.0 at a wavelength of 10 μm; and a medium.

<2> The far infrared ray transmitting composition according to <1>, in which 15 mass % or more of the particle is contained with respect to a total solid content of the far infrared ray transmitting composition.

<3> The far infrared ray transmitting composition according to <1> or <2>, in which the medium includes at least one selected from a resin, a curable compound, and a solvent.

<4> The far infrared ray transmitting composition according to any one of <1> to <3>, in which the particle is an inorganic particle including at least one atom selected from Ge, Zn, Si, and F.

<5> A formed body comprising: a particle having a refractive index of 1.3 to 5.0 at a wavelength of 10 μm.

<6> The formed body according to <5>, in which an average refractive index in a wavelength range of 8 to 14 μm is 1.3 to 5.0.

<7> The formed body according to <5> or <6>, in which a shape of the formed body is a film shape, a flat sheet shape, or a lens shape.

<8> The formed body according to any one of <5> to <7>, in which the particle is an inorganic particle including at least one atom selected from Ge, Zn, Si, and F.

<9> The formed body according to any one of <5> to <8>, which is used for a far infrared ray transmitting filter.

<10> A laminate comprising: a substrate; and the formed body according to any one of <5> to <9>, which is provided on the substrate.

<11> The laminate according to <10>, in which a refractive index n1 of the formed body at a wavelength of 10 μm and a refractive index n2 of a layer that is in contact with the formed body in a thickness direction of the formed body at a wavelength of 10 μm satisfy the following relationship.

(n2)^{0.5}−1≤n1≤(n2)^{0.5}+1

<12> The laminate according to <10> or <11>, in which a product of a refractive index n1 of the formed body at a wavelength of 10 μm and a thickness T of the formed body satisfies the following relationship:

1.5<T·n1<3.5,

where a unit of T is μm.

<13> The laminate according to any one of <10> to <12>, which is used for a far infrared ray transmitting filter.

<14> A far infrared ray transmitting filter comprising: the formed body according to any one of <5> to <9> or the laminate according to any one of <10> to <13>.

<15> A solid-state imaging device comprising: the far infrared ray transmitting filter according to <14>.

<16> An infrared camera comprising: the far infrared ray transmitting filter according to <14>.

According to the present invention, it is possible to provide a far infrared ray transmitting composition that can manufacture a formed body having far infrared ray transmitting properties, a formed body, a laminate, a far infrared ray transmitting filter, a solid-state imaging device, and an infrared camera.

### DESCRIPTION OF THE PREFERRED EMBODIMENTS

Hereinafter, the content of the present invention is specifically described.

Descriptions of the components described below may be made based on representative embodiments of the present invention, but the present invention is not limited to the embodiments.

In the present specification, the numerical range expressed by using “to” means a range including numerical values described before and after “to” as a lower limit value and an upper limit value.

In the present specification, the “total solid content” refers to the total mass of components obtained by removing the solvent from the entire composition of the composition.

With respect to an indication of a group (atomic group) in the present specification, an indication in which substitution or unsubstitution is not described includes a group (atomic group) having a substituent together with a group (atomic group) not having a substituent. For example, an “alkyl group” includes not only an alkyl group not having a substituent (unsubstituted alkyl group) but also an alkyl group having a substituent (substituted alkyl group).

In the present specification, “(meth)acrylate” represents acrylate and methacrylate, “(meth)acryl” means acryl and methacryl, and “(meth)acryloyl” means acryloyl and methacryloyl.

Unless described otherwise, the expression “exposure” in the present specification includes not only exposure using light but also drawing by particle beams such as electron beams or ion beams. Generally, examples of the light used for exposure include a bright line spectrum of a mercury lamp, far ultraviolet rays represented by excimer laser, actinic rays or radiation such as extreme ultraviolet rays (EUV light), X-rays, or electron beams.

In the present specification, the “far infrared rays” means light (electromagnetic waves) having a wavelength of 0.7 to 1,000 μm.

In the present specification, the weight-average molecular weight and the number average molecular weight are defined as values in terms of polystyrene measured by gel permeation chromatography (GPC).

<Far Infrared Ray Transmitting Composition>

The far infrared ray transmitting composition (hereinafter, also referred to as a “composition of the present invention”) of the present invention includes a particle having a refractive index of 1.3 to 5.0 at a wavelength of 10 μm and a medium.

In a case where the composition of the present invention is used, it is possible to manufacture a formed body having excellent far infrared ray transmitting properties. According to the composition of the present invention, the formed body may be manufactured by applying the composition of the present invention to a substrate, or by using the composition of the present invention by various forming methods such as injection, pressing and extrusion, and thus it is possible easily to manufacture a formed body having excellent far infrared ray transmitting properties. For this reason, it is possible to manufacture a formed body having far infrared ray transmitting properties at low cost.

In the composition of the present invention, it is preferable that the medium is liquid or solid at 25° C.

In the composition of the present invention, the particle is preferably dispersed in a medium. That is, in the far infrared ray transmitting composition of the present invention, the medium is preferably a component obtained by dispersing a particle. The medium is preferably an organic material. It is preferable that the medium includes at least one selected from a resin, a curable compound, and a solvent.

According to the present invention, it is preferable that the far infrared ray transmitting composition includes an inorganic particle including at least one atom selected from Ge, Zn, Si, and F and a medium. The inorganic particle including at least one atoms selected from Ge, Zn, Si, and F having a high refractive index at a wavelength of 10 μm. In a case where the inorganic particle is included, it is possible to manufacture a formed body having excellent far infrared ray transmitting properties.

Hereinafter, the composition of the present invention is specifically described.

<Particle Having Refractive Index of 1.3 to 5.0 at Wavelength of 10 μm>

The composition of the present invention contains a particle (hereinafter, also referred to as a “high refractive index particle”) having a refractive index of 1.3 to 5.0 at a wavelength of 10 The lower limit of the refractive index of a high refractive index particle at a wavelength of 10 μm is preferably 1.35 or more and more preferably 1.4 or more. The upper limit is preferably 4.5 or less and more preferably 4.0 or less. According to the present invention, as the refractive index of the particle, a well-known numerical value is used with respect to a material of which the numerical value of bulk crystals is known, and a value obtained by forming a vapor deposition film of a compound forming a measurement target particle and by performing measurement by IR-VASE manufactured by J. A. Woollam Co. is used with respect to a material of which the number of bulk crystals is not known.

An average primary particle diameter of the high refractive index particle is preferably 100 nm or less and more preferably 50 nm or less. The lower limit can be, for example, 1 nm or more and can be 10 nm or more. In a case where the average primary particle diameter of the high refractive index particle is 100 nm or less, it is possible to expect an effect in which scattering of infrared light is suppressed and the transmittance is increased. According to the present invention, the average primary particle diameter of the high refractive index particle can be obtained by observing a portion where the particles are not aggregated by a transmission electron microscope (TEM). According to the present invention, the particle size distribution of particles is obtained by capturing a transmission electron micrograph of particles which are primary particles by using a transmission electron microscope and then measuring the particle size distribution with the image processing device by using the micrograph. According to the present invention, the average primary particle diameter of the particles is an average primary particle diameter with the number average diameter calculated from the particle size distribution. In the present specification, an electron microscope (H-7000) manufactured by Hitachi, Ltd. is used as a transmission electron microscope, and LUZEX AP manufactured by Nireco Corporation is used as an image processing device.

As high refractive index particles, any particles having a refractive index of 1.3 to 5.0 at a wavelength of 10 μm can be preferably used, an inorganic particle including at least one atom selected from Ge, Zn, Si and F, indium tin oxide (ITO), chalcogenide glass, diamond, and sapphire is more preferable, and an inorganic particle including at least one atom selected from Ge, Zn, Si, and F is more preferable. Specific examples of the high refractive index particle include a Ge particle, a Si particle, a GeO₂ particle, a ZnSe particle, a ZnS particle, a CaF₂ particle, a MgF₂ particle, a BaF₂ particle, and chalcogenide glass, a Ge particle and a Si particle are preferable, and a Ge particle is more preferable. In a case where these particles are used, a formed body having excellent far infrared ray transmitting properties is easily manufactured. Examples of commercially available products of the ITO particles include P4-ITO (manufactured by Mitsubishi Materials Corporation). Examples of commercially available products of the Si particles include SO—Cl (manufactured by Admatechs Company Limited) and AEROSIL 50 and MOX 170 and 200 (manufactured by Nippon Aerosil Co., Ltd.). Examples of commercially available products of the MgF₂ particle, the BaF₂ particle, and the CaF particle include products of Morita Chemical Industries Co., Ltd., Stella Chemifa Corporation. Examples of commercially available products of the Ge particle include products of HWNANO Materials, products of Americanelements. The high refractive index particles may be obtained by crushing commercially available materials or crystals and then refining the materials or the crystals using a laboplast mill or the like.

The shape of the high refractive index particle may be, for example, an isotropic shape (for example, a spherical shape and a polyhedral shape), an anisotropic shape (for example, a needle shape, a rod shape, and a plate shape), and an irregular shape.

The high refractive index particles may be particles surface-treated with a surface treatment agent. Examples of the surface treatment agent used for the surface treatment include polyol, aluminum oxide, aluminum hydroxide, silica (silicon oxide), hydrous silica, alkanol amine, stearic acid, organosiloxane, zirconium oxide, hydrogen dimethicone, a silane coupling agent, and a titanate coupling agent. In the surface treatment, the surface treatment agent may be used singly, or two or more kinds of surface treatment agents may be used in combination.

In view of far infrared ray transmitting properties and rigidity of the formed body, the content of the high refractive index particle is preferably high, more preferably 15 mass % or more, even more preferably 30 mass % or more, and particularly preferably 45 mass % or more with respect to the total solid content of the composition. The upper limit is preferably 99.9 mass % or less and more preferably 90 mass % or less.

<<Resin>>

The composition of the present invention preferably includes a resin. For example, the resin is formulated, for example, for the application in which the high refractive index particles are dispersed in the composition and for the application of the binder. The resin used for mainly dispersing the high refractive index particle in the composition is referred to as dispersing agent. These applications of the resin are provided as examples, and a resin can be used for the purpose other than these applications.

The weight-average molecular weight (Mw) of the resin is preferably 2,000 to 2,000,000. The upper limit is preferably 1,000,000 or less and more preferably 500,000 or less. The lower limit is preferably 3,000 or more and more preferably 5,000 or more.

The content of the resin is preferably 0.1 to 80 mass % with respect to the total solid content of the composition. The lower limit is preferably 0.01 mass % or more and more preferably 1 mass % or more. The upper limit is preferably 80 mass % or less and more preferably 70 mass % or less. The resin may be included singly, or two or more kinds thereof may be included. In a case where two or more kinds thereof are included, it is preferable that the total amount thereof is in the above range.

(Binder)

The composition of the present invention preferably contains a binder as the resin. Examples of the binder include a (meth)acrylic resin, a (meth)acrylamide resin, an epoxy resin, an enethiol resin, a polycarbonate resin, a polyether resin, a polyarylate resin, a polysulfone resin, a polyethersulfone resin, a polyphenylene resin, a polyarylene ether phosphine oxide resin, a polyimide resin, a polyamide imide resin, a polyolefin resin, a cyclic olefin resin, a polyester resin, a styrene resin, and a siloxane resin. These resins may be used singly or two or more kinds thereof may be used in combination.

As the resin, a resin having an acid group can also be used. Examples of the acid group include a carboxy group, a phosphoric acid group, a sulfo group, and a phenolic hydroxy group. These acid groups may be used singly or two or more kinds thereof may be used in combination. The resin having an acid group can also be used as an alkali-soluble resin. The resin having an acid group can also be used as a dispersing agent.

Examples of the resin having an acid group include a radical polymer having a carboxy group in a side chain, for example, polymers disclosed in JP1984-44615A (JP-S59-44615A), JP1979-34327B (JP-S54-34327B), JP1983-12577B (JP-S58-12577B), JP1979-25957B (JP-S54-25957B), JP1979-92723A (JP-S54-92723A), JP1984-53836A (JP-S59-53836A), JP1984-71048A (JP-S59-71048A), that is, a resin obtained by homopolymerizing or copolymerizing a monomer having a carboxy group, a resin obtained by homopolymerizing or copolymerizing a monomer having acid anhydride and hydrolyzing, half-esterifying, or half-amidating an acid anhydride unit, and epoxy acrylate obtained by modifying an epoxy resin with unsaturated monocarboxylic acid and acid anhydride. Examples of the monomer having a carboxy group include an acrylic acid, a methacrylic acid, an itaconic acid, a crotonic acid, a maleic acid, a fumaric acid, and a 4-carboxystyrene, and examples of the monomer having an acid anhydride include maleic acid anhydride. An acidic cellulose derivative having a carboxy group in a side chain can also be used.

The molecular weight of the resin having an acid group is not particularly limited, and it is preferable that the weight-average molecular weight (Mw) is 5,000 to 200,000. The upper limit is preferably 100,000 or less and more preferably 20,000 or less. The number average molecular weight (Mn) is preferably 1,000 to 20,000.

The acid value of the resin having an acid group is preferably 30 to 500 mg KOH/g. The lower limit is more preferably 50 mgKOH/g or more and even more preferably 70 mgKOH/g or more. The upper limit is more preferably 400 mgKOH/g or less, even more preferably 200 mgKOH/g or less, particularly preferably 150 mgKOH/g or less, and most preferably 120 mgKOH/g or less.

As the resin having an acid group, a polymer having a carboxy group in the side chain is preferable, and examples thereof include an alkali-soluble phenolic resin such as a methacrylic acid copolymer, an acrylic acid copolymer, an itaconic acid copolymer, a crotonic acid copolymer, a maleic acid copolymer, a partially esterified maleic acid copolymer, and a novolak type resin, an acidic cellulose derivative having a carboxy group in a side chain, and an acid anhydride added to a polymer having a hydroxy group. Particularly, a copolymer of (meth)acrylic acid and another monomer copolymerizable with (meth)acrylic acid is preferable. Examples of the other monomer copolymerizable with (meth)acrylic acid include alkyl (meth)acrylate, aryl (meth)acrylate, a vinyl compound, and a N-substituted maleimide monomer. Examples of the alkyl (meth)acrylate and the aryl (meth)acrylate, methyl (meth)acrylate, ethyl (meth)acrylate, propyl (meth)acrylate, butyl (meth)acrylate, isobutyl (meth)acrylate, pentyl (meth)acrylate, hexyl (meth)acrylate, octyl (meth)acrylate, phenyl (meth)acrylate, benzyl (meth)acrylate, tolyl (meth)acrylate, naphthyl (meth)acrylate, and cyclohexyl (meth)acrylate, and examples of the vinyl compound include styrene, α-methylstyrene, vinyl toluene, glycidyl methacrylate, acrylonitrile, vinyl acetate, N-vinyl pyrrolidone, tetrahydrofurfuryl methacrylate, a polystyrene macromonomer, and a polymethyl methacrylate macromonomer. As other monomers, N-phenylmaleimide, N-cyclohexylmaleimide, and the like can also be used as the N-substituted maleimide monomer disclosed in JP1998-300922A (JP-H10-300922A). These monomers copolymerizable with (meth)acrylic acid may be used singly or two or more kinds thereof may be used in combination.

The resin having an acid group, a benzyl (meth)acrylate/(meth)acrylic acid copolymer, a benzyl (meth)acrylate/(meth)acrylic acid/2-hydroxyethyl (meth)acrylate copolymer, and a multi-copolymer consisting of a benzyl (meth)acrylate/(meth)acrylic acid/other monomer can also be preferably used. A 2-hydroxypropyl (meth)acrylate/polystyrene macromonomer/benzyl methacrylate/methacrylic acid copolymer, a 2-hydroxy-3-phenoxypropyl acrylate/polymethyl methacrylate macromonomer/benzyl methacrylate/methacrylic acid copolymer, a 2-hydroxyethyl methacrylate/polystyrene macromonomer/methyl methacrylate/methacrylic acid copolymer, and a 2-hydroxyethyl methacrylate/polystyrene macromonomer/benzyl methacrylate/methacrylic acid copolymer which are obtained by copolymerizing 2-hydroxyethyl (meth)acrylate and disclosed in JP1995-140654A (JP-H7-140654A) can be preferably used.

It is also preferable that the resin having an acid group includes a polymer obtained by polymerizing a monomer component including at least one (hereinafter, the compound is also referred to as an “ether dimer”) selected from a compound represented by Formula (ED1) and a compound represented by Formula (ED2).

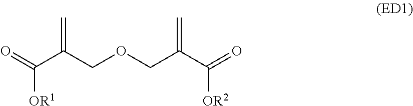

In Formula (ED1), R¹ and R² each independently represent a hydrogen atom or a hydrocarbon group having 1 to 25 carbon atoms which may have a substituent.

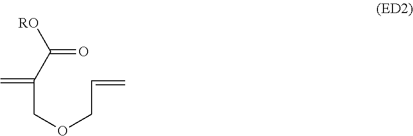

In Formula (ED2), R represents a hydrogen atom or an organic group having 1 to 30 carbon atoms. As specific example of Formula (ED2), the description of JP2010-168539A can be referred to.

As a specific example of the ether dimer, for example, paragraph 0317 of JP2013-29760A can be referred to, and the content thereof is incorporated into the present specification. The ether dimer may be used singly or two or more kinds thereof may be used in combination.

The resin having an acid group may include a structural unit derived from a compound represented by Formula (X).

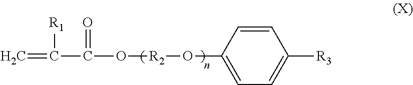

In Formula (X), R₁ represents a hydrogen atom or a methyl group, R₂ represents an alkylene group having 2 to 10 carbon atoms, and R₃ represents a hydrogen atom or an alkyl group having 1 to 20 carbon atoms which may contain a benzene ring. n represents an integer of 1 to 15.

In Formula (X), the number of carbon atoms in the alkylene group of R₂ is preferably 2 to 3. The number of carbon atoms in the alkyl group of R₃ is 1 to 20 and more preferably 1 to 10, and the alkyl group of R₃ may include a benzene ring. Examples of the benzene ring-containing alkyl group represented by R₃ include a benzyl group and a 2-phenyl (iso)propyl group.

As the resin having an acid group, the description of paragraphs 0558 to 0571 (corresponding to paragraph 0685 to 0700 of US2012/0235099A) of JP2012-208494A can be referred to, and the content thereof is incorporated into the present specification. A copolymer (B) disclosed in paragraph 0029 to 0063 and alkali-soluble resins used in examples of JP2012-32767A, binder resins disclosed in paragraphs 0088 to 0098 and binder resins used in examples of JP2012-208474A, binder resins disclosed in paragraph 0022 to 0032 and binder resins used in examples of JP2012-137531A, binder resins disclosed in paragraphs 0132 to 0143 and binder resins used in examples of JP2013-024934A, binder resins disclosed in paragraph 0092 to 0098 and used in examples of JP2011-242752A, and binder resins disclosed in paragraph 0030 to 0072 of JP2012-032770A can also be used. The contents thereof are incorporated into the present specification. Specific examples of the resin having an acid group include the following resins.

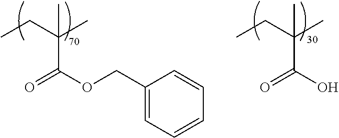

The resin may have a curable group. Examples of the curable group include a group having an ethylenically unsaturated bond, an epoxy group, a methylol group, and an alkoxysilyl group. Examples of the group having an ethylenically unsaturated bond include a vinyl group, a (meth)allyl group, a (meth)acryloyl group, and a (meth)acryloyloxy group. Examples of the alkoxysilyl group include a monoalkoxysilyl group, a dialkoxysilyl group, and a trialkoxysilyl group. The resin having a curable group is also a curable compound.

Examples of the resins containing a curable group include DIANAL NR series (manufactured by Mitsubishi Rayon Co., Ltd.), PHOTOMER 6173 (polyurethane acrylic oligomer containing COOH, manufactured by Diamond Shamrock Co., Ltd.), VISCOAT R-264 and KS RESIST 106 (all manufactured by Osaka Organic Chemical Industry Ltd.), CYCLOMER P series (for example, ACA230AA), PLACCEL CF 200 series (all manufactured by Daicel Corporation), EBECRYL 3800 (manufactured by Daicel UCB Co., Ltd.), and ACRICURE RD-F8 (manufactured by Nippon Shokubai Co., Ltd.).

According to the present invention, as the resin, MARPROOF G-0150M, G-0105SA, G-0130SP, G-0250SP, G-10055, G-1005SA, G-1010S, G-2050M, G-01100, and G-01758 (manufactured by NOF Corporation, epoxy group-containing polymer), and ARTON F4520 (manufactured by JSR Corporation), are also preferably used.

The content of the binder is preferably 0.01 to 80 mass % with respect to the total solid content of the composition. The lower limit is preferably 0.1 mass % or more and more preferably 1 mass % or more. The upper limit is preferably 80 mass % or less and more preferably 70 mass % or less. The binders may be contained singly or two or more kinds thereof may be contained in combination. In a case where two or more kinds are included, it is preferable that the total amount thereof is in the above range.

(Dispersing Agent)

The composition of the present invention can contain a dispersing agent as the resin. Examples of the dispersing agent include polymer dispersants [for example, a resin having an amine group (polyamidoamine and a salt thereof), an oligoimine-based resin, polycarboxylic acid and a salt thereof, high molecular weight unsaturated acid ester, modified polyurethane, modified polyester, modified poly(meth)acrylate, a (meth)acrylic copolymer, and a naphthalene sulfonic acid formalin condensate]. From the structure thereof, the polymer dispersant can be classified into a linear polymer, a terminal-modified polymer, a graft-type polymer, and a block-type polymer.

It is preferable that the dispersing agent has a site having adsorption ability to the high refractive index particles (hereinafter, collectively referred to as an “adsorption site”). Examples of the adsorption site include a monovalent substituent having at least one group selected from the group consisting of an acid group, a urea group, a urethane group, a group having a coordinating oxygen atom, a group having a basic nitrogen atom, a heterocyclic group, an alkyloxycarbonyl group, an alkylaminocarbonyl group, a carboxy group, a sulfonamide group, an alkoxysilyl group, an epoxy group, an isocyanate group, and a hydroxy group. The adsorption site is preferably an acid-based adsorption site. Examples of the acid-based adsorption site include an acid group. Among these, it is preferable that the acid-based adsorption site is at least one of a phosphorus atom-containing group and a carboxy group. Examples of the phosphorus atom-containing group include a phosphoric acid ester group, a polyphosphoric acid ester group, and a phosphoric acid group. With respect to the details of the adsorption site, paragraphs 0073 to 0080 of JP2015-34961A can be referred to, and the content thereof is incorporated into the present specification.

According to the present invention, the resin (dispersing agent) is preferably a resin represented by Formula (100).

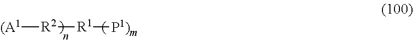

In Formula (100), R¹ represents a (m+n)-valent linking group, and R² represents a single bond or a divalent linking group. A¹ represents a monovalent substituent having at least one group selected from the group consisting of an acid group, a urea group, a urethane group, a group having a coordinating oxygen atom, a group having a basic nitrogen atom, a phenol group, an alkyl group, an aryl group, a group having an alkyleneoxy chain, an imide group, a heterocyclic group, an alkyloxycarbonyl group, an alkylaminocarbonyl group, a carboxylic acid salt group, a sulfonamide group, an alkoxysilyl group, an epoxy group, an isocyanate group, and a hydroxy group. n A¹'s and R²'s may be identical to or different from each other. m represents a positive number of 8 or less, n represents 1 to 9, and m+n satisfies 3 to 10. P¹ represents a monovalent polymer chain. m P¹'s may be identical to or different from each other.

In Formula (100), A¹ represents a monovalent substituent having at least one group (hereinafter, also referred to as an “adsorption site”) selected from the group consisting of an acid group, a urea group, a urethane group, a group having a coordinating oxygen atom, a group having a basic nitrogen atom, a phenol group, an alkyl group, an aryl group, a group having an alkyleneoxy chain, an imide group, a heterocyclic group, an alkyloxycarbonyl group, an alkylaminocarbonyl group, a carboxylic acid salt group, a sulfonamide group, an alkoxysilyl group, an epoxy group, an isocyanate group, and a hydroxy group. At least one adsorption site may be included in one A¹, and two or more adsorption sites may be included. In one A¹, examples of the aspect in which two or more adsorption sites are included include an aspect in which two or more adsorption sites are combined to form a monovalent substituent via a chain-like saturated hydrocarbon group (which may be linear or branched and which preferably has 1 to 10 carbon atoms), a cyclic saturated hydrocarbon group (preferably having 3 to 10 carbon atoms), and an aromatic group (preferably having 5 to 10 carbon atoms, for example, a phenylene group), and an aspect in which two or more adsorption sites are bonded via a chain-like saturated hydrocarbon group to form a monovalent substituent is preferable. In a case where the adsorption site forms a monovalent substituent, the adsorption site may be a monovalent substituent represented by A¹. First, the adsorption site forming A¹ is described below.

Examples of the acid group in A¹ include a carboxy group, a sulfo group, a monosulfuric acid ester group, a phosphoric acid group, a monophosphoric acid ester group, a phosphonic acid group, a phosphinic acid group, and a boric acid group. A carboxy group, a sulfo group, a monosulfuric acid ester group, a phosphoric acid group, a monophosphoric acid ester group, a phosphonic acid group, or a phosphinic acid group is preferable, a carboxy group, a sulfo group, a phosphoric acid group, a phosphonic acid group, or a phosphinic acid group is more preferable, and a carboxy group is even more preferable.

Examples of the urea group in A¹ include NR¹⁵CONR¹⁶R¹⁷ (here, R¹⁵, R¹⁶, and R¹⁷ each independently represent a hydrogen atom, an alkyl group having 1 to 20 carbon atoms, an aryl group having 6 or more carbon atoms, or an aralkyl group having 7 or more carbon atoms). —NR¹⁵CONHR¹⁷ is preferable, and —NHCONHR¹⁷ is more preferable.

Examples of the urethane group in A¹ include —NHCOOR¹⁸, —NR¹⁹COOR²⁰, —OCONHR²¹, and —OCONR²²R²³ (here, R¹⁸, R¹⁹, R²⁰, R²¹, R²², and R²³ each independently represent an alkyl group having 1 to 20 carbon atoms, an aryl group having 6 or more carbon atoms, or an aralkyl group having 7 or more carbon atoms.) —NHCOOR¹⁸ and —OCONHR²¹ are preferable.

Examples of the group having a coordinating oxygen atom in A¹ include an acetylacetonato group and crown ether.

Examples of the group having a basic nitrogen atom in A¹ include an amino group (—NH₂), a substituted imino group (—NHR⁸ and —NR⁹R¹⁰, here, R⁸, R⁹, and R¹⁰ each independently represent an alkyl group having 1 to 20 carbon atoms, an aryl group having 6 or more carbon atoms, and an aralkyl group having 7 or more carbon atoms), a guanidyl group represented by Formula (a1), and an amidinyl group represented by Formula (a2).

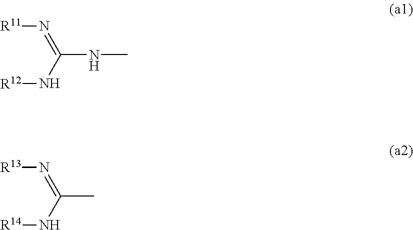

In Formula (a1), and R¹⁻² each independently represent an alkyl group having 1 to 20 carbon atoms, an aryl group having 6 or more carbon atoms, and an aralkyl group having 7 or more carbon atoms.

In Formula (a2), R¹³ and R¹⁴ each independently represent an alkyl group having 1 to 20 carbon atoms, an aryl group having 6 or more carbon atoms, and an aralkyl group having 7 or more carbon atoms.

The group having a basic nitrogen atom is preferably an amino group (—NH₂), a substituted imino group, a guanidyl group represented by Formula (a1) [in Formula (a1), and R¹² each independently represent an alkyl group having 1 to 10 carbon atoms, a phenyl group, and a benzyl group], and an amidinyl group represented by Formula (a2) [in Formula (a2), R¹³ and R¹⁴ each independently represent an alkyl group having 1 to 10 carbon atoms, a phenyl group, and a benzyl group]. Particularly, an amino group (—NH₂), a substituted imino group (—NHR⁸ and —NR⁹R¹⁰, here, R⁸, R⁹, and R¹⁰ each independently represent an alkyl group having 1 to 5 carbon atoms, a phenyl group, or a benzyl group), a guanidyl group represented by Formula (a1) [in Formula (a1), and R¹⁻² each independently represent an alkyl group having 1 to 5 carbon atoms, a phenyl group, or a benzyl group], and an amidinyl group represented by Formula (a2) [in Formula (a2), R¹³ and R¹⁴ each independently represent an alkyl group having 1 to 5 carbon atoms, a phenyl group, or a benzyl group] are preferable.

The alkyl group in A¹ may be linear or branched, preferably an alkyl group having 1 to 40 carbon atoms, more preferably an alkyl group having 4 to 30 carbon atoms, and even more preferably an alkyl group having 10 to 18 carbon atoms.

The aryl group in A¹ is preferably an aryl group having 6 to 10 carbon atoms.

The group having an alkyleneoxy chain in A¹ is preferably a group forming an alkyloxy group and more preferably a group forming an alkyloxy group having 1 to 20 carbon atoms at the terminal thereof. The alkyleneoxy chain is not particularly limited as long as the alkyleneoxy chain has at least one alkyleneoxy group, and preferably includes an alkyleneoxy group having 1 to 6 carbon atoms. Examples of the alkyleneoxy group include —CH₂CH₂O— and —CH₂CH₂CH₂O—.

The alkyl group moiety in the alkyloxycarbonyl group in A¹ is preferably an alkyl group having 1 to 20 carbon atoms.

The alkyl group moiety in the alkylaminocarbonyl group in A¹ is preferably an alkyl group having 1 to 20 carbon atoms.

Examples of the carboxylic acid salt group in A¹ include a group including ammonium salt of carboxylic acid.

As the sulfonamide group in A¹, a hydrogen atom bonded to a nitrogen atom of a sulfonamide group may be substituted with an alkyl group (a methyl group and the like), and an acyl group (an acetyl group, a trifluoroacetyl group, and the like).

Examples of the heterocyclic group in A¹ include a thiophene ring group, a furan ring group, a xanthene ring group, a pyrrole ring group, a pyrroline ring group, a pyrrolidine ring group, a dioxolane ring group, a pyrazole ring group, a pyrazoline ring group, a pyrazolidine ring group, an imidazole ring group, an oxazole ring group, a thiazole ring group, an oxadiazole ring group, a triazole ring group, a thiadiazole ring group, a pyran ring group, a pyridine ring group, a piperidine ring group, a dioxane ring group, a morpholine ring group, a pyridazine ring group, a pyrimidine ring group, a piperazine ring group, a triazine ring group, a trithiane ring group, an isoindoline ring group, an isoindolinone ring group, a benzimidazolone ring group, a benzothiazole ring group, a hydantoin ring group, an indole ring group, a quinoline ring group, a carbazole ring group, an acridine ring group, an acridone ring group, and an anthraquinone ring group.

Examples of the imide group in A¹ include a succinimide group, a phthalimide group, and a naphthalimide group.

The above heterocyclic group and imide group may further have a substituent. Examples of the substituent include an alkyl group having 1 to 20 carbon atoms such as a methyl group and an ethyl group, an aryl group having 6 to 16 carbon atoms such as a phenyl group and a naphthyl group, an acyloxy group having 1 to 6 carbon atoms such as a hydroxy group, an amino group, a carboxyl group, a sulfonamide group, a N-sulfonylamide group, and an acetoxy group, an alkoxy group having 1 to 20 carbon atoms such as a methoxy group and an ethoxy group, a halogen atom such as a chlorine atom and a bromine atom, an alkoxycarbonyl group having 2 to 7 carbon atoms such as a methoxycarbonyl group, an ethoxycarbonyl group, and a cyclohexyloxycarbonyl group, and a carbonic acid ester group such as a cyano group and t-butyl carbonate.

The alkoxysilyl group in A¹ may be any one of a monoalkoxysilyl group, a dialkoxysilyl group, and a trialkoxysilyl group, a trialkoxysilyl group is preferable, and examples thereof include a trimethoxysilyl group and a triethoxysilyl group.

Examples of the epoxy group in A¹ include a substituted or unsubstituted oxirane group (ethylene oxide group).

In Formula (100), R¹ represents (m+n)-valent linking group. Examples of the (m+n)-valent linking group include a group having 1 to 100 carbon atoms, 0 to 10 nitrogen atoms, 0 to 50 oxygen atoms, 1 to 200 hydrogen atoms, and 0 to 20 sulfur atoms.

The (m+n)-valent linking group is preferably a group represented by any one of the following formulae.

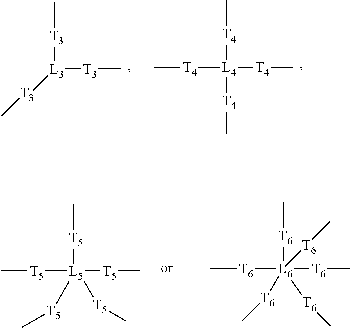

L₃ represents a trivalent group. T₃ represents a single bond or a divalent linking group, and three of T₃'s may be identical to or different from each other.

L₄ represents a tetravalent group. T₄ represents a single bond or a divalent linking group, and four of T₄'s may be identical to or different from each other.

L₅ represents a pentavalent group. T₅ represents a single bond or a divalent linking group, and five of T₅'s may be identical to or different from each other.

L₆ represents a hexavalent group. T₆ represents a single bond or a divalent linking group, and six of T₆'s may be identical to or different from each other.

Specific examples of the (m+n)-valent linking group include the following structural unit or a group (which may form a ring structure) obtained by combining two or more of the following structural units. For details of the (m+n)-valent linking group, paragraph 0043 to 0055 of JP2014-177613A can be referred to, and the content thereof is incorporated into the present specification.

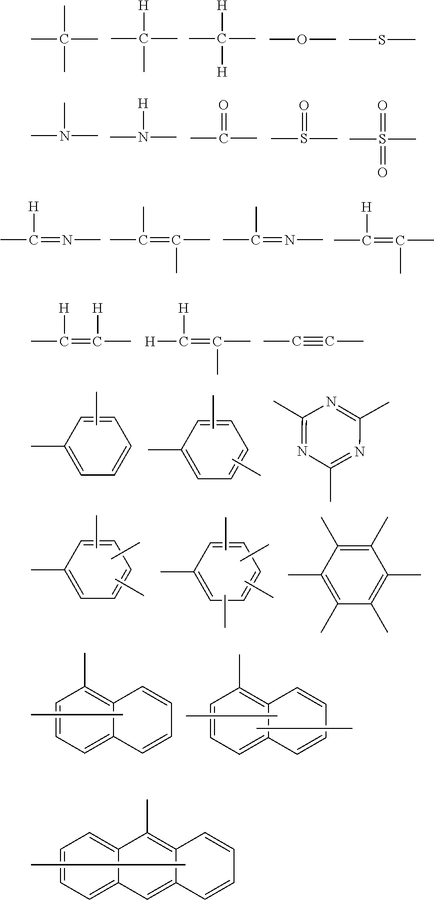

In Formula (100), P¹ represents a monovalent polymer chain. A monovalent polymer chain is preferably at least one selected from the group consisting of a vinyl-based polymer, an ester-based polymer, an ether-based polymer, a urethane-based polymer, an amide-based polymer, an epoxy-based polymer, a silicone-based polymer, and a modified product or a copolymer thereof [including, for example, a polyether/polyurethane copolymer, a copolymer of polyether/vinyl monomer polymer (may be a random copolymer, a block copolymer, or a graft copolymer)], and more preferably at least one selected from the group consisting of a vinyl-based polymer, an ester-based polymer, an ether-based polymer, a urethane-based polymer, and a modified product or a copolymer thereof.

The monovalent polymer chain represented by P¹ is preferably a polymer chain having a structure represented by Formulae (L), (M) and (N).

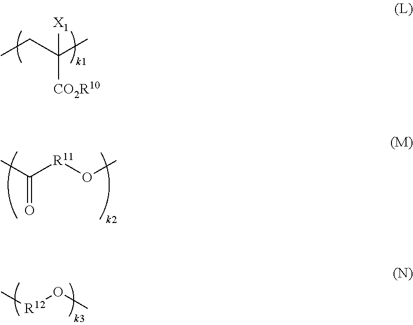

In the formula, X¹ represents a hydrogen atom or a monovalent organic group. X¹ is preferably a hydrogen atom or an alkyl group having 1 to 12 carbon atoms, more preferably a hydrogen atom or a methyl group, and particularly preferably a methyl group.

R¹⁰ represents a hydrogen atom or a monovalent organic group, preferably a hydrogen atom, an alkyl group, an aryl group, or a heteroaryl group, and more preferably a hydrogen atom or an alkyl group. In a case where R¹⁰ is an alkyl group, the alkyl group is preferably a linear alkyl group having 1 to 20 carbon atoms, a branched alkyl group having 3 to 20 carbon atoms, or a cyclic alkyl group having 5 to 20 carbon atoms, more preferably a linear alkyl group having 1 to 20 carbon atoms, and particularly preferably a linear alkyl group having 1 to 6 carbon atoms. Two or more kinds of R^{m} having different structures may be included in Formula (L).

R¹¹ and R¹² each represent a branched or linear alkylene group (preferably having 1 to 10 carbon atoms, more preferably 2 to 8 carbon atoms, and even more preferably 3 to 6 carbon atoms). Two or more kinds of R¹¹ or R¹² having different structures may be included in each general formula.

k1, k2, and k3 each independently represent a number of 5 to 140.

P¹ preferably contains at least one repeating unit. In view of exhibiting a steric repulsive force and improving dispersibility, the repetition number k1 to k3 of the repeating unit in P¹ is more preferably 5 or more. In view of causing the high refractive index particles to be densely present in the film, the above repeating number k1 to k3 of the repeating unit is preferably 50 or less, more preferably 40 or less, and even more preferably 30 or less.

The monovalent polymer chain represented by P¹ is preferably soluble in an organic solvent. As long as the monovalent polymer chain is soluble in an organic solvent, affinity with an organic solvent is satisfactory, and the dispersion stabilization of high refractive particles can be improved.

In Formula (100), R² represents a single bond or a divalent linking group. Examples of the divalent linking group include a group including 1 to 100 carbon atoms, 0 to 10 nitrogen atoms, 0 to 50 oxygen atoms, 1 to 200 hydrogen atoms, and 0 to 20 sulfur atoms. The above group may be unsubstituted or may further have a substituent. Specific examples of the divalent linking group include the following structural unit or a group obtained by combining two or more of the following structural units. Details of the divalent linking group include paragraphs 0071 to 0075 of JP2007-277514A, and the content thereof is incorporated into the present specification.

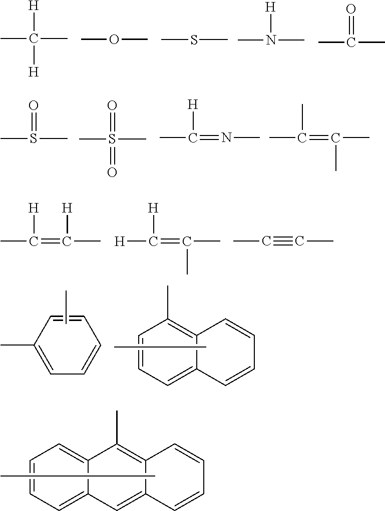

In Formula (100), m represents a positive number of 8 or less. m is preferably 0.5 to 5, more preferably 1 to 4, and particularly preferably 1 to 3.

In Formula (100), n represents 1 to 9. n is preferably 2 to 8, more preferably 2 to 7, and particularly preferably 3 to 6.

The resin represented by Formula (100) is preferably a resin represented by Formula (100a).

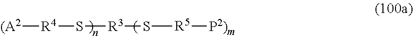

In Formula (100a), A² represents a monovalent substituent having at least one group selected from the group consisting of an acid group, a urea group, a urethane group, a group having a coordinating oxygen atom, a group having a basic nitrogen atom, a phenol group, an alkyl group, an aryl group, a group having an alkyleneoxy chain, an imide group, a heterocyclic group, an alkyloxycarbonyl group, an alkylaminocarbonyl group, a carboxylic acid salt group, a sulfonamide group, an alkoxysilyl group, an epoxy group, an isocyanate group, and a hydroxy group. R³ represents a (m+n)-valent linking group. R⁴ and R⁵ represent a single bond or a divalent linking group. P² represents a monovalent polymer chain. m represents a positive number of 8 or less, n represents 1 to 9, and m+n satisfies 3 to 10. n items of A² and R⁴ may be identical to each other and m items of P² and R⁵ may be identical to or different from each other.

A² of Formula (100a) is the same as A¹ of Formula (100), and preferable aspects thereof are also the same.

In Formula (100a), as the divalent linking groups represented by R⁴ and R⁵, those as exemplified as divalent linking groups represented by R² of Formula (100) may be used, and preferable aspects thereof are also the same.

In Formula (100a), examples of the (m+n)-valent linking group represented by R³ include a group having 1 to 100 carbon atoms, 0 to 10 nitrogen atoms, 0 to 50 oxygen atoms, 1 to 200 hydrogen atoms, and 0 to 20 sulfur atoms. Details of the (m+n)-valent linking group include (m+n)-valent linking groups described in R¹ of Formula (100), and preferable aspects thereof are also the same.

In Formula (100a), m and n are also the same as m and n in Formula (100), and preferable aspects thereof are also the same.

In Formula (100), the monovalent polymer chain represented by P² is the same as P¹ in (100), and preferable aspects thereof are also the same.

The resin represented by Formula (100) is preferably a resin represented by Formula (100b).

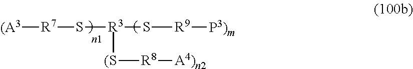

In Formula (100b), R⁶ represents a (m+n1+n2)-valent linking group. R⁷ to R⁹ each independently represent a single bond or a divalent linking group. A³ represents a monovalent substituent having at least one acid group. A⁴ represents a monovalent substituent different from A³. P³ represents a monovalent polymer chain. m represents a positive number of 8 or less, n1 represents 1 to 8, n2 represents 1 to 8, and m+n1+n2 satisfies 3 to 10. n1 items of A³ and R⁷ may be identical to or different from each other. n2 items of A⁴ and R⁸ may be identical to or different from each other.

m in Formula (100b) is the same as m in Formula (100), and preferable aspects are also the same.

P³ in Formula (100b) is the same as P¹ in Formula (100), and preferable aspects are also the same.

Examples of the (m+n1+n2)-valent linking group represented by R⁶ in Formula (100b) include groups having 1 to 100 carbon atoms, 0 to 10 nitrogen atoms, 0 to 50 oxygen atoms, 1 to 200 hydrogen atoms, and 0 to 20 sulfur atoms. Details of the (m+n1+n2)-valent linking group include (m+n)-valent linking groups described in R¹ of Formula (100), and preferable aspects are also the same.

As the divalent linking group represented by R⁷ to R⁹ in Formula (100b), divalent linking groups as represented by R² of Formula (100) are used, and preferable aspects are also the same.

Preferable examples of the acid group represented by A³ in Formula (100b) include a carboxy group, a sulfo group, a monosulfuric acid ester group, a phosphoric acid group, a monophosphoric acid ester group, a phosphonic acid group, a phosphinic acid group, and a boric acid group, a carboxy group, a sulfo group, a monosulforic acid ester group, a phosphoric acid group, a monophosphoric acid ester group, a phosphonic acid group, and a phosphinic acid group are preferable, a carboxy group, a sulfo group, a phosphoric acid group, a phosphonic acid group, and a phosphinic acid group are more preferable, and a carboxy group is even more preferable.

Examples of the monovalent substituent represented by A⁴ in Formula (100b) include a monovalent substituent (excluding an acid group) described in A¹ in Formula (100). Among these, a monovalent substituent having at least one functional group having pKa of 5 or more is preferable, a monovalent substituent having at least one group selected from the group consisting of a group having a coordinating oxygen atom, a group having a basic nitrogen atom, a phenol group, a urea group, a urethane group, an alkyl group, an aryl group, an alkyloxycarbonyl group, an alkylaminocarbonyl group, a group having an alkyleneoxy chain, an imide group, a carboxylic acid salt group, a sulfonamide group, a hydroxy group, and a heterocyclic group are more preferable, and an alkyl group, an aryl group, a group having a coordinating oxygen atom, a group having a basic nitrogen atom, a urea group, and a urethane group are even more preferable.

As a combination of A³ and A⁴, a combination in which A³ is a monovalent substituent having at least one functional group having pKa of less than 5 and A⁴ is a monovalent substituent having at least one functional group having pKa 5 or more is preferable.

It is more preferable that A³ is a monovalent substituent having at least one group selected from the group consisting of a carboxyl group, a sulfo group, a phosphoric acid group, a phosphonic acid group, and a phosphinic acid group, and A⁴ is a monovalent substituent having at least one group selected from the group consisting of a group having a coordinating oxygen atom, a group having a basic nitrogen atom, a phenol group, a urea group, a urethane group, an alkyl group, an aryl group, an alkyloxycarbonyl group, an alkylaminocarbonyl group, a group having an alkyleneoxy chain, an imide group, a carboxylic acid salt group, a sulfonamide group, a hydroxy group, and a heterocyclic group. It is even more preferable that A³ is a monovalent substituent having a carboxyl group, and A⁴ is an alkyl group, an aryl group, a group having a coordinating oxygen atom, a group having a basic nitrogen atom, a urea group, or a urethane group.

The weight-average molecular weight of the resin represented by Formula (100) is preferably 1,000 to 50,000, more preferably 3,000 to 30,000, and even more preferably 3,000 to 20,000. In the above range, the dispersibility of high refractive particles is satisfactory.

As the resin represented by Formula (100), paragraph 0039 of JP2007-277514A (corresponding to <0053> of US2010/0233595A) and paragraphs 0081 to 0117 of JP2015-34961A can be referred to, and the contents thereof are incorporated into the present specification. Specific examples of the resin represented by Formula (100) include the following resins. Examples thereof include resins disclosed in paragraphs 0223 to 0291 of JP2014-177613A, paragraphs 0229 to 0295 of JP2014-062221A, paragraphs 0251 to 0337 of JP2014-177614A, and the contents thereof are incorporated into the present specification.

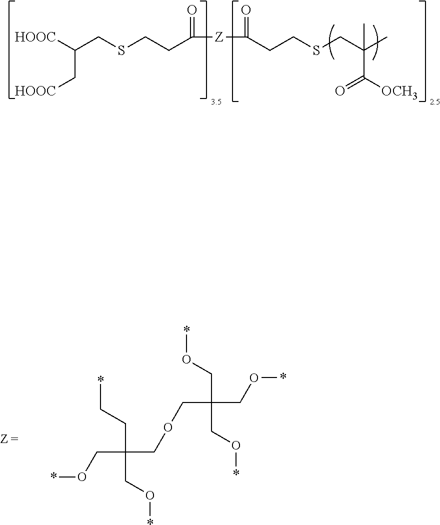

A method of synthesizing a resin represented by Formula (100) is not particularly limited, and examples thereof include a method of manufacturing a resin by radically polymerizing a vinyl monomer in the presence of a mercaptan compound having a plurality of adsorption sites. With respect to the details of the method of synthesizing the resin represented by Formula (100), paragraphs 0114 to 0140 and 0266 to 0348 of JP2007-277514A and paragraphs 0077 to 0108 of JP2014-177614A can be referred to, and the content thereof is incorporated into the present specification.

In the present invention, as the resin (dispersing agent), a graft copolymer including a repeating unit represented by any one of Formulae (111) to (114) may be used.

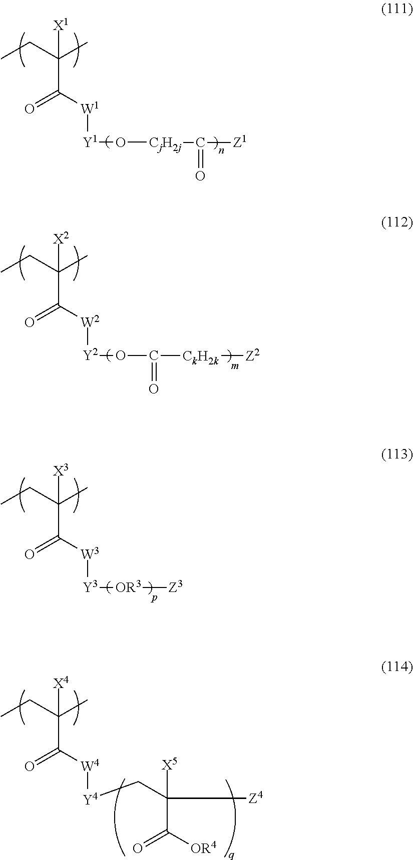

In Formulae (111) to (114), W², W³, and W⁴ each independently represent an oxygen atom or NH, X¹, X², X³, X⁴, and X⁵ each independently represent a hydrogen atom or a monovalent group, Y¹, Y², Y³, and Y⁴ each independently represent a divalent linking group, Z¹, Z², Z³, and Z⁴ each independently represent a monovalent group, R³ represents an alkylene group, R⁴ represents a hydrogen atom or a monovalent group, n, m, p, and q each independently represent an integer of 1 to 500, j and k each independently represent an integer of 2 to 8, in Formula (113), in a case where p is 2 to 500, a plurality of R³'s are identical to or different from each other, and in Formula (114), in a case where q is 2 to 500, a plurality of X⁵'s and R⁴'s may be identical to or different from each other.

W¹, W², W³, and W⁴ are preferably oxygen atoms. X¹, X², X³, X⁴, and X⁵ are preferably a hydrogen atom or an alkyl group having 1 to 12 carbon atoms, each independently and more preferably represent a hydrogen atom or a methyl group, and particularly preferably a methyl group. Y¹, Y², Y³, and Y⁴ each independently represent a divalent linking group, and the linking group is not particularly limited in terms of the structure. The structures of the monovalent group represented by Z¹, Z², Z³, and Z⁴ are not particularly limited, and specific examples thereof include an alkyl group, a hydroxy group, an alkoxy group, an aryloxy group, a heteroaryloxy group, an alkylthioether group, aryl thioether group, a heteroaryl thioether group, and an amino group. Among these, particularly, in view of improving the dispersibility, the monovalent groups represented by Z¹, Z², Z³, and Z⁴ preferably have a steric repulsion effect and are each independently preferably an alkyl group or an alkoxy group of 5 to 24 carbon atoms. Among these, particularly, the monovalent groups each independently and preferably represent a branched alkyl group having 5 to 24 carbon atoms, a cyclic alkyl group having 5 to 24 carbon atoms, or an alkoxy group having 5 to 24 carbon atoms. The alkyl group included in the alkoxy group may be linear, branched or cyclic.

In Formulae (111) to (114), n, m, p, and q each independently represent an integer of 1 to 500. In Formulae (111) and (112), j and k each independently represent an integer of 2 to 8. In view of dispersion stability and developability, j and k in Formulae (111) and (112) are preferably an integer of 4 to 6 and most preferably 5.

In Formula (113), R³ represents an alkylene group, preferably an alkylene group having 1 to 10 carbon atoms, and more preferably an alkylene group having 2 or 3 carbon atoms. In a case where p is 2 to 500, a plurality of R³'s may be identical to or different from each other.

In Formula (114), R⁴ represents a hydrogen atom or a monovalent group. The monovalent group is not particularly limited in terms of the structure. R⁴ is preferably a hydrogen atom, an alkyl group, an aryl group, or a heteroaryl group and more preferably a hydrogen atom or an alkyl group. In a case where R⁴ is an alkyl group, a linear alkyl group having 1 to 20 carbon atoms, a branched alkyl group having 3 to 20 carbon atoms, or a cyclic alkyl group having 5 to 20 carbon atoms is preferable, a linear alkyl group having 1 to 20 carbon atoms is more preferable, and a linear alkyl group having 1 to 6 carbon atoms is particularly preferable. In Formula (114), in a case where q is 2 to 500, X⁵ and R⁴ present in plural in the graft copolymer may be identical to or different from each other.

With respect to the graft copolymer, the resin described in paragraphs 0025 to 0094 of JP2012-255128A is referred to, and the content thereof is incorporated into the present specification. The description of paragraphs 0072 to 0094 of JP2012-255128A is referred to, and the content thereof is incorporated into the present specification.

The resin (dispersing agent) is also preferably an oligoimine-based dispersing agent including a basic nitrogen atom in at least one of the main chain and the side chain. As the oligoimine-based dispersing agent, a resin having a side chain including a repeating unit having a partial structure X having a functional group having pKa of 14 or less and an oligomer chain or a polymer chain Y having atoms of 40 to 10,000 and having basic nitrogen atoms in a main chain and at least one side chain is preferable. Since this resin interacts with high refractive index particles on both sides of a nitrogen atom and the functional group of pKa of 14 or less which is included by a structure X, and the resin has an oligomer chain or polymer chain Y having 40 to 10,000 atoms, the oligomer chain or polymer chain Y functions as a steric repulsive group, such that satisfactory dispersibility is exhibited, and high refractive index particles can be uniformly dispersed. The sedimentation of the high refractive index particles can be suppressed for a long period of time by interaction between the oligomer chain and polymer chain Y or the solvent. Since the oligomer chain or the polymer chain Y functions as a steric repulsive group, aggregation of the high refractive index particles is prevented, so even in a case where the content of the high refractive index particles is increased, excellent dispersibility can be obtained.

Here, the “basic nitrogen atom” is not particularly limited, as long as the basic nitrogen atom is a basic nitrogen atom, and the resin preferably contains a structure having a nitrogen atom having pKb of 14 or less, and more preferably contains a structure having a nitrogen atom having pKb of 10 or less. “pKb (base strength)” according to the present invention refers to pKb at a water temperature of 25° C. and is one of the indexes for quantitatively expressing the base strength, and the basicity constant is also the same. The base strength pKb and the acid strength pKa have a relationship of pKb=14−pKa.

The functional group having pKa of 14 or less included in the partial structure X is not particularly limited, and the structure and the like are not particularly limited as long as the physical properties satisfy this condition. Particularly, a functional group having pKa of 12 or less is preferable, and a functional group having a pKa of 11 or less is most preferable. Specific examples thereof include a carboxy group (pKa of about 3 to 5), a sulfo group (pKa of about −3 to −2), a —COCH₂CO-group (pKa of about 8 to 10), a —COCH₂CN group (pKa of about 8 to 11), a —CONHCO— group, a phenolic hydroxy group, a —R_{F}CH₂OH group, a —(R_{F})₂CHOH group (R_{F} represents a perfluoroalkyl group, pKa of about 9 to 11), and a sulfonamide group (pKa of about 9 to 11). It is preferable that the partial structure X having a functional group of pKa 14 or less is directly bonds to a basic nitrogen atom in a repeating unit containing a nitrogen atom, and the basic nitrogen atom of the repeating unit containing a basic nitrogen atom and the partial structure X may be linked in an aspect of forming a covalent bond or an ionic bond to form a salt.

The oligoimine-based dispersing agent is preferably a resin having a repeating unit containing a basic nitrogen atom to which a partial structure X having a functional group having pKa of 14 or less is bonded and the oligomer chain or polymer chain Y having atoms of 40 to 10,000 in a side chain.

The oligoimine-based dispersing agent is preferably a resin having (i) a repeating unit which is a repeating unit containing a basic nitrogen atom which is at least one selected from a poly(lower alkylene imine)-based repeating unit, a polyallyl amine-based repeating unit, a polydiallyl amine-based repeating unit, a metaxylene diamine-epichlorohydrin polycondensate-based repeating unit, and a polyvinyl amine-based repeating unit, which is bonded to a basic nitrogen atom, and which has the partial structure X having a functional group of pKa of 14 or less, and (ii) the oligomer chain or polymer chain Y having 40 to 10,000 atoms in the side chain. According to the present invention, the expression “lower” in poly(lower alkylene imine) indicates that the number of carbon atoms is 1 to 5, and the “lower alkylene imine” indicates alkylene imine having 1 to 5 carbon atoms.

Examples of the oligomer chain or polymer chain Y having 40 to 10,000 atoms include well-known polymer chains such as polyester, polyamide, polyimide, and poly(meth)acrylic acid ester which can be connected to the main chain portion of the resin. The bonding site of the oligomer chain or polymer chain Y to the resin is preferably a terminal of the oligomer chain or polymer chain Y.

The oligomer chains or polymer chains Y is preferably bonded to a nitrogen atom of the repeating unit containing at least one nitrogen atom, which is selected from a poly(lower alkylene imine)-based repeating unit, a polyallyl amine-based repeating unit, a polydiallyl amine-based repeating unit, a metaxylene diamine-epichlorohydrin polycondensate-based repeating unit, and a polyvinyl amine-based repeating unit. A bonding aspect of the main chain moiety of a repeating unit containing at least one nitrogen atom or the like, which is selected from a poly(lower alkylene imine)-based repeating unit, a polyallyl amine-based repeating unit, a polydiallyl amine-based repeating unit, a metaxylene diamine-epichlorohydrin polycondensate-based repeating unit, and a polyvinyl amine-based repeating unit to Y is a covalent bond, an ionic bond, and a mixture of a covalent bond and an ionic bond. The proportion of the bonding aspect between Y and the main chain moiety is covalent bond:ionic bond=100:0 to 0:100 and preferably 95:5 to 5:95. It is preferable that Y forms an amide bond to a nitrogen atom of a repeating unit containing a nitrogen atom or form an ionic bond as carboxylic acid salt.

In view of dispersibility, dispersion stability, and developability, the number of atoms of the oligomer chain or polymer chain Y is preferably 50 to 5,000 and more preferably 60 to 3,000. The number average molecular weight of Y can be measured by a value in terms of polystyrene by the GPC method. The number average molecular weight of Y is preferably 1,000 to 50,000 and more preferably 1,000 to 30,000.

Examples of the oligoimine-based dispersing agent include a resin including a repeating unit represented by Formula (I-1), a repeating unit represented by Formula (I-2) and/or a repeating unit represented by Formula (I-2a) and the like.

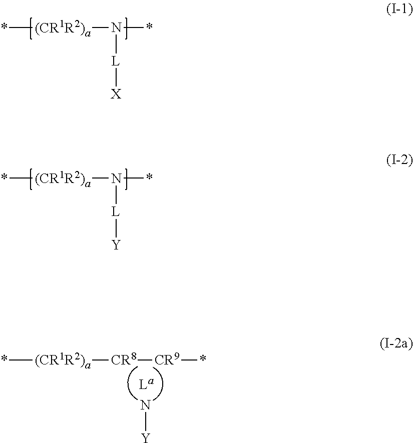

R¹ and R² each independently represent a hydrogen atom, a halogen atom, or an alkyl group (preferably having 1 to 6 carbon atoms).

a's each independently represent an integer of 1 to 5. * represents a linking site between repeating units.

R⁸ and R⁹ are groups which are the same as

L is a single bond, an alkylene group (preferably having 1 to 6 carbon atoms), an alkenylene group (preferably having 2 to 6 carbon atoms), an arylene group (preferably having 6 to 24 carbon atoms), a heteroarylene group (preferably having 1 to 6 carbon atoms), an imino group (preferably having 0 to 6 carbon atoms), an ether group, a thioether group, a carbonyl group, or a linking group relating to a combination thereof. Among these, a single bond or —CR⁵R⁶—NR′— (the imino group becomes any one of X and Y) is preferable. Here, R⁵ and R⁶ each independently represent a hydrogen atom, a halogen atom, and an alkyl group (preferably having 1 to 6 carbon atoms). R⁷ a hydrogen atom or an alkyl group having 1 to 6 carbon atoms.

L^{a} is a structural moiety that forms a ring structure together with CR⁸CR⁹ and N and is preferably a structural moiety that forms a nonaromatic heterocyclic ring having 3 to 7 carbon atoms together with the carbon atoms of CR⁸CR⁹. A structural moiety that forms a 5- to 7-membered nonaromatic heterocyclic ring in combination with carbon atoms of CR⁸CR⁹ and N (nitrogen atom) is even more preferable, and a structural moiety that forms a 5-membered nonaromatic heterocyclic ring is more preferable, and a structural moiety that forms pyrrolidine is particularly preferable. This structural moiety may further have a substituent such as an alkyl group. X represents a group having a functional group having pKa of 14 or less. Y represents an oligomer chain or polymer chain having 40 to 10,000 atoms.

The dispersing agent (oligoimine-based dispersing agent) may further contain one or more kinds selected from the repeating units represented by Formulae (I-3), (I-4), and (I-5), as copolymer components. In a case where the dispersing agent includes the repeating unit, it is possible to further improve the dispersion performance of the high refractive index particles.

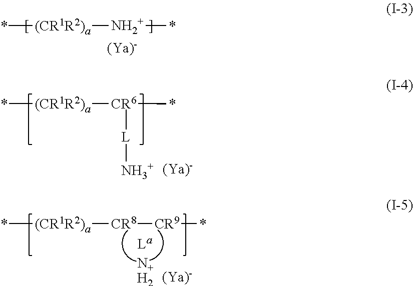

R¹, R², R⁸, R⁹, L, L^{a}, a, and * are the same as defined in Formulae (I-1), (I-2), and (I-2a). Ya represents an oligomer chain or polymer chain having an anionic group and having 40 to 10,000 atoms.

With respect to the oligoimine-based dispersing agent, the descriptions of paragraphs 0118 to 0190 of JP2015-34961A can be referred to, and the contents are incorporated into the present specification. Specific examples of the oligoimine-based dispersing agent include the following resins and resins disclosed in paragraphs 0169 to 0190 of JP2015-34961A.

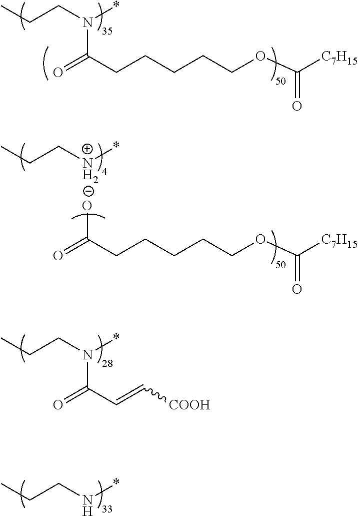

The dispersing agent is also available as a commercially available product, and specific examples thereof include “DISPERBYK 101, 103, 107, 110, 180, 130, 161, 162, 163, 164, 165, 166, and 170” manufactured by BYK Chemie GmbH, “BYK-P104, P105 (high molecular weight unsaturated polycarboxylic acid)” manufactured by BYK Chemie GmbH, “EFKA4047, 4050, 4010, and 4165 (polyurethane-based), EFKA4330, 4340 (block copolymer), 4400, and 4402 (modified polyacrylate), 5010 (polyester amide), 5765 (high molecular weight polycarboxylic acid salt), 6220 (fatty acid polyester), 6745 (phthalocyanine derivative), and 6750 (azo pigment derivative)” manufactured by BASF SE, “AJISPER PB821 and PB822” manufactured by Ajinomoto Fine-Techno Co., Inc., “FLOREN TG-710 (urethane oligomer)” manufactured by manufactured by Kyoeisha Chemical Co., Ltd., “POLYFLOW No. 50E, No. 300 (acrylic copolymer)” manufactured by manufactured by Kyoeisha Chemical Co., Ltd., “DISPARLON KS-860, 873SN, 874, #2150 (aliphatic polycarboxylic acid), #7004 (polyether ester), DA-703-50, DA-705, and DA-725” manufactured by Kusumoto Chemicals, Ltd., “DEMOL RN, N (naphthalenesulfonic acid formalin polycondensate), MS, C, and SN-B (aromatic sulfonic acid formalin polycondensate)” manufactured by KAO Corp., “HOMOGENOL L-18 (polymer polycarboxylic acid)” manufactured by KAO Corp., “EMULGEN 920, 930, 935, and 985 (polyoxyethylene nonylphenyl ether)” and “ACETAMINE 86 (stearyl amine acetate)” manufactured by KAO Corp., “SOLSPERSE 5000 (Solsperse 5000) (phthalocyanine derivative), 22000 (azo pigment derivative), 13240 (polyester amine), 3000, 17000, 27000 (a polymer having a functional portion at a terminal portion), 24000, 26000, 28000, 32000, 36000, and 38500 (graft-type polymer), and 41000” manufactured by The Lubrizol Corporation, and “NIKKOL T106 (polyoxyethylene sorbitan monooleate) and MYS-IEX (polyoxyethylene monostearate)” manufactured by Nikko Chemicals Co., Ltd. Examples of the commercially available product of a dispersing agent having a phosphorus atom-containing group (for example, a phosphoric acid group) as an acid-based adsorption site include “SOLSPERSE 26000, 36000, and 41000” manufactured by The Lubrizol Corporation. These can be suitably used.

The dispersing agent can be used singly or two or more kinds thereof can be used in combination.

The content of the dispersing agent is preferably 0.1 to 40 mass % with respect to the total solid content of the composition. The upper limit is preferably 20 mass % or less and more preferably 10 mass % or less. The lower limit is preferably 0.5 mass % or more and more preferably 1 mass % or more.

The content of the dispersing agent is preferably 1 to 100 parts by mass with respect to 100 parts by mass of the high refractive index particle. The upper limit is preferably 80 parts by mass or less and more preferably 60 parts by mass or less. The lower limit is preferably 2.5 parts by mass or more and more preferably 5 parts by mass or more.

<<Solvent>>

The composition of the present invention preferably contains a solvent. The solvent can be formed by using various organic solvents. Examples of the organic solvent include acetone, methyl ethyl ketone, cyclohexane, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetylacetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethyl sulfoxide, γ-butyrolactone, methyl lactate, and ethyl lactate. These organic solvents can be used singly or in a mixture.

According to the present invention, it is preferable that a solvent having a small metal content is used as the solvent. It is preferable that the metal content of the solvent is, for example, 10 mass ppb (parts per billion) or less. If necessary, one having a mass ppt (parts per trillion) level may be used, and the high purity solvent is, for example, provided by Toyo Gosei Co., Ltd. (Japan Chemical Daily, Nov. 13, 2015).

Examples of the method for removing impurities such as metals from a solvent include distillation (molecular distillation, thin film distillation, and the like) and filtration using a filter. The pore size of the filter used for filtration is preferably 10 nm or less, more preferably 5 nm or less, and even more preferably 3 nm or less. As the filter, a filter formed of polytetrafluoroethylene, polyethylene, or nylon is preferable.

The solvent may include an isomer (a compound having the same number of atoms and different structures). Only one kind of isomers may be included, or a plurality of kinds of isomers may be included.

With respect to the content of the solvent, the concentration of solid contents of the composition is preferably 5 to 99 mass %. The upper limit is more preferably 90 mass % or less. The lower limit is more preferably 10 mass % or more.

<<Curable Compound>>

The composition of the present invention preferably contains a curable compound. As the curable compound, a well-known compound that can be cured by radical, acid, or heat can be used. Examples thereof include a compound having a group having an ethylenically unsaturated bond, a compound having an epoxy group, and a compound having a methylol group. Examples of the group having an ethylenically unsaturated bond include a vinyl group, a (meth)allyl group, a (meth)acryloyl group, and a (meth)acryloyloxy group, and a (meth)acryloyl group and a (meth)acryloyloxy group are preferable. The curable compound is preferably a polymerizable compound and is more preferably a radically polymerizable compound. Examples of the polymerizable compound include a compound having a group having an ethylenically unsaturated bond.

(Compound Having Group Having Ethylenically Unsaturated Bond (Polymerizable Compound))

According to the present invention, as the curable compound, a compound (hereinafter, referred to as a “polymerizable compound”) having a group having an ethylenically unsaturated bond can be used. The polymerizable compound is preferably a monomer. The molecular weight of the polymerizable compound is preferably 100 to 3,000. The upper limit is preferably 2,000 or less and more preferably 1,500 or less. The lower limit is preferably 150 or more and more preferably 250 or more. The polymerizable compound is preferably a 3 to 15 functional (meth)acrylate compound and more preferably a 3 to 6 functional (meth)acrylate compound.

The polymerizable compound is also preferably a compound having one or more groups having an ethylenically unsaturated bond and having a boiling point of 100° C. or more under atmospheric pressure. Specific examples thereof include monofunctional acrylate or methacrylate such as polyethylene glycol mono(meth)acrylate, polypropylene glycol mono(meth)acrylate, and phenoxyethyl(meth)acrylate; polyethylene glycol di(meth)acrylate, trimethylol ethane tri(meth)acrylate, neopentyl glycol di(meth)acrylate, pentaerythritol tri(meth)acrylate, pentaerythritol tetra(meth)acrylate, dipentaerythritol penta(meth)acrylate, dipentaerythritol hexa(meth)acrylate, hexanediol (meth)acrylate, trimethylolpropane tri(acryloyloxypropyl)ether, tri(acryloyloxyethyl) isocyanurate, and a mixture thereof, and pentaerythritol tetra(meth)acrylate is preferable.

As the polymerizable compound, polymerizable compounds represented by Formulae (MO-1) to (MO-5) can also be suitably used. In the formula, in a case where T is an oxyalkylene group, the terminal on the carbon atom side is bonded to R.

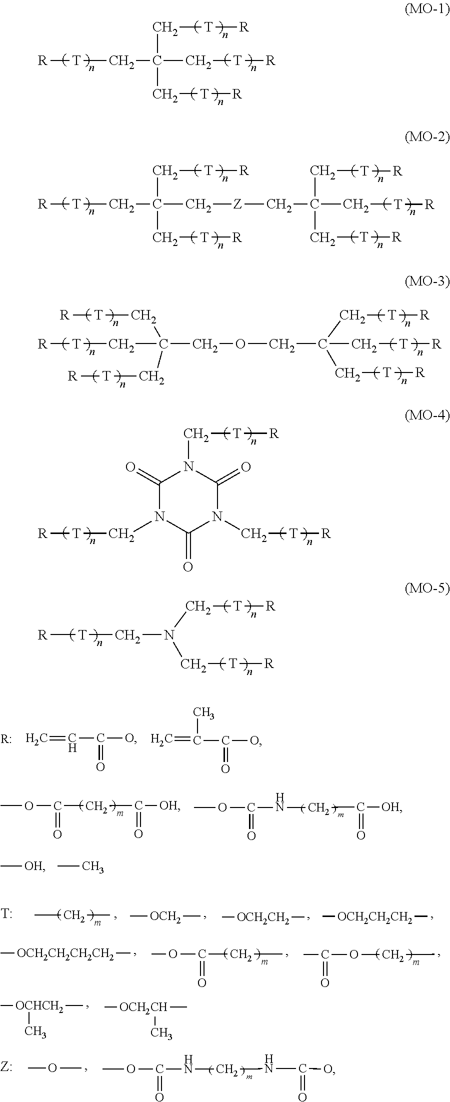

In the above formula, n is an integer of 0 to 14, and m is an integer of 1 to 8. A plurality of R's and T's which are present in one molecule may be identical to or different from each other.

In each of the polymerizable compounds represented by Formulae (MO-1) to (MO-5), at least one in the plurality of R's represents a group represented by —OC(═O)CH═CH₂, or —OC(═O)C(CH₃)═CH₂.

Specific examples of the polymerizable compound represented by Formulae (MO-1) to (MO-5) include compounds disclosed in paragraphs 0248 to 0251 of JP2007-269779A.

A compound which is disclosed in JP1998-62986A (JP-H10-62986A) and which is obtained by adding ethylene oxide or propylene oxide to polyfunctional alcohol and then (meth)acrylating the mixture can also be used as the polymerizable compound.

The polymerizable compound is preferably pentaerythritol tetraacrylate (as a commercially available product, A-TMMT; Shin-Nakamura Chemical Co., Ltd.), dipentaerythritol triacrylate (as a commercially available product, KAYARAD D-330; manufactured by Nippon Kayaku Co., Ltd.), dipentaerythritol tetraacrylate (as a commercially available product, KAYARAD D-320; manufactured by Nippon Kayaku Co., Ltd.), dipentaerythritol penta(meth)acrylate (as a commercially available product, KAYARAD D-310; manufactured by Nippon Kayaku Co., Ltd.), and dipentaerythritol hexa(meth)acrylate (as a commercially available product, KAYARAD DPHA; manufactured by Nippon Kayaku Co., Ltd.), and more preferably pentaerythritol tetraacrylate.

The polymerizable compound may have an acid group such as a carboxy group, a sulfo group, and a phosphoric acid group. The polymerizable compound having an acid group can be obtained by (meth)acrylating a hydroxy group which is a part of polyfunctional alcohol and performing addition reaction on an acid anhydride to the remaining hydroxy group to obtain a carboxy group. Examples of the polymerizable compound having an acid group include an ester of an aliphatic polyhydroxy compound and unsaturated carboxylic acid. It is preferable that the polymerizable compound having an acid group is a compound obtained by reacting an unreacted hydroxy group of an aliphatic polyhydroxy compound with nonaromatic carboxylic acid anhydride to have acid group, and it is particularly preferable that in this ester, the aliphatic polyhydroxy compound is pentaerythritol and/or dipentaerythritol. Examples of commercially available products thereof include M-305, M-510, and M-520 of the Aronix series as polybasic acid-modified acrylic oligomers manufactured by Toagosei Co., Ltd. The acid value of the polymerizable compound having an acid group is preferably 0.1 to 40 mg KOH/g. The lower limit is preferably 5 mgKOH/g or more. The upper limit is preferably 30 mgKOH/g or less.

A polymerizable compound having a caprolactone structure is also a preferable aspect of the polymerizable compound. The polymerizable compound having a caprolactone structure is not particularly limited, as long as the polymerizable compound has a caprolactone structure in a molecule, and examples thereof include ε-caprolactone modified polyfunctional (meth)acrylate obtained by esterifying (meth)acrylic acid and ε-caprolactone with polyhydric alcohol such as trimethylol ethane, ditrimethylol ethane, trimethylolpropane, ditrimethylolpropane, pentaerythritol, dipentaerythritol, tripentaerythritol, glycerin, diglycerol, and trimethylol melamine. The polymerizable compound having a caprolactone structure is preferably a compound represented by Formula (Z-1).

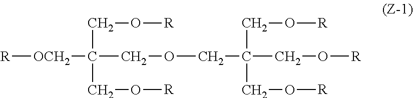

In Formula (Z-1), all of six R's are groups represented by Formula (Z-2), or one to five of the six R's are groups represented by Formula (Z-2), and the remaining is a group represented by Formula (Z-3).

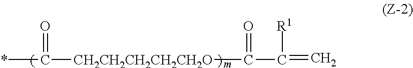

In Formula (Z-2), R¹ represents a hydrogen atom or a methyl group, m represents 1 or 2, and “*” represents a bonding site.

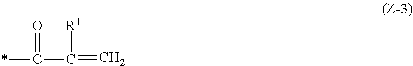

In Formula (Z-3), R¹ represents a hydrogen atom or a methyl group, and “*” represents a bonding site.

Examples of the polymerizable compound having a caprolactone structure include DPCA-20 (compound in which m=1 in Formulae (Z-1) to (Z-3), the number of groups represented by Formula (Z-2)=2, and all R¹'s are hydrogen atoms), DPCA-30 (compound in which m=1 in Formulae (Z-1) to (Z-3), the number of groups represented by Formula (Z-2)=3, and all R¹ are hydrogen atoms), DPCA-60 (compound in which m=1 in Formulae (Z-1) to (Z-3), the number of groups represented by Formula (Z-2)=6, and all R¹ are hydrogen atoms), DPCA-120 (compound in which m=2 in Formulae (Z-1) to (Z-3), the number of groups represented by Formula (Z-2)=6, and all R¹ are hydrogen atoms), which are commercially available from Nippon Kayaku Co., Ltd. as the KAYARAD DPCA series.

As the polymerizable compound, a compound represented by Formula (Z-4) or (Z-5) can be used.

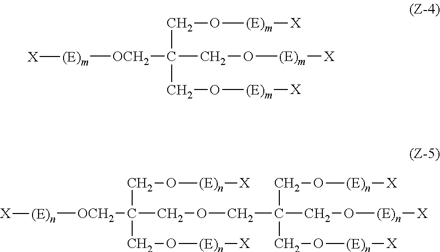

In Formulae (Z-4) and (Z-5), E each independently represent —((CH₂)_{y}CH₂O)—, or —((CH₂)_{y}CH(CH₃)O)—, y's each independently represent an integer of 0 to 10, and X's each independently represent a (meth)acryloyl group, a hydrogen atom, or a carboxy group.

In Formula (Z-4), a total number of (meth)acryloyl groups is 3 or 4, m each independently represents an integer of 0 to 10, and the sum of m's is an integer of 0 to 40.

In Formula (Z-5), a total number of (meth)acryloyl groups is 5 or 6, n each independently represents an integer of 0 to 10, and the sum of n's is an integer of 0 to 60.

In Formula (Z-4), m is preferably an integer of 0 to 6 and more preferably an integer of 0 to 4.

The sum of m's is preferably an integer of 2 to 40, more preferably an integer of 2 to 16, and particularly preferably an integer of 4 to 8.

In Formula (Z-5), n is preferably an integer of 0 to 6 and more preferably an integer of 0 to 4.

The sum of n's is preferably an integer of 3 to 60, more preferably an integer of 3 to 24, and particularly preferably an integer of 6 to 12.

—((CH₂)_{y}CH₂O)— or —((CH₂)_{y}CH(CH₃)O)— in Formula (Z-4) or (Z-5) is preferably an aspect in which the terminal on the oxygen atom side is bonded to X.

The compound represented by Formula (Z-4) or (Z-5) may be used singly or two or more kinds thereof may be used in combination. Particularly, in Formula (Z-5), an aspect in which all six X's are acryloyl groups is preferable.

The total content of the compound represented by Formula (Z-4) or (Z-5) in the polymerizable compound is preferably 20 mass % or more and more preferably 50 mass % or more.

The compound represented by Formula (Z-4) or (Z-5) can be synthesized by a step of bonding an open ring skeleton to pentaerythritol or dipentaerythritol by ethylene oxide or propylene oxide by a ring opening addition reaction and a step of introducing a (meth)acryloyl group by reacting, for example, (meth)acryloyl chloride to the terminal hydroxy group of the ring-opening skeleton, which are well-known steps in the related art. Each step is a well-known step, and a person skilled in the art can easily synthesize the compound represented by Formula (Z-4) or (Z-5).

Among the compounds represented by Formula (Z-4) or (Z-5), pentaerythritol derivatives and/or dipentaerythritol derivatives are more preferable.

Specific examples thereof include compounds represented by Formulae (a) to (f) (hereinafter also referred to as “example compounds (a) to (f)”), and, among which the example compounds (a), (b), (e), and (f) are preferable.

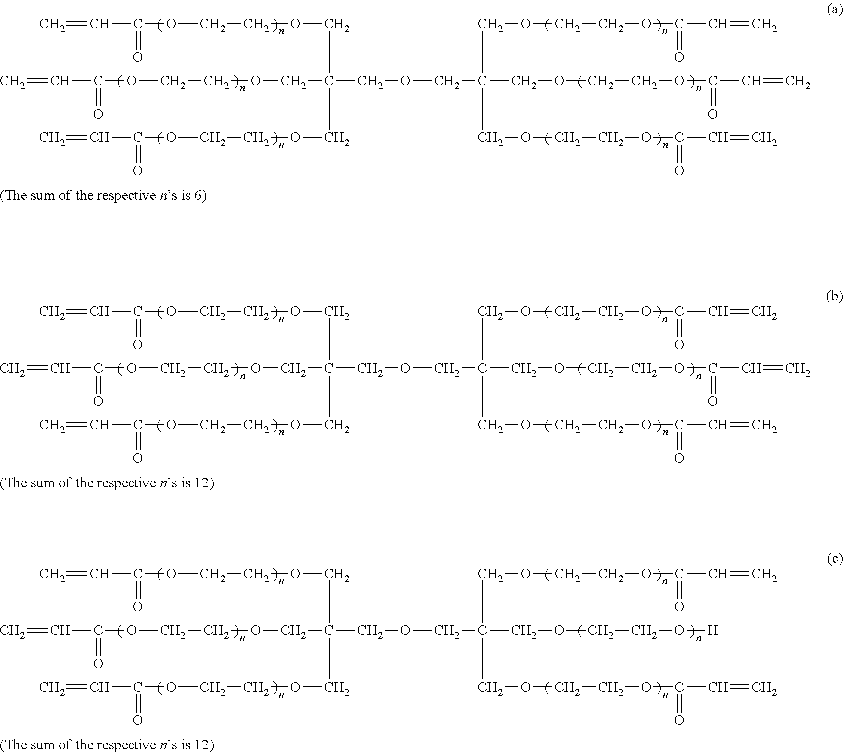

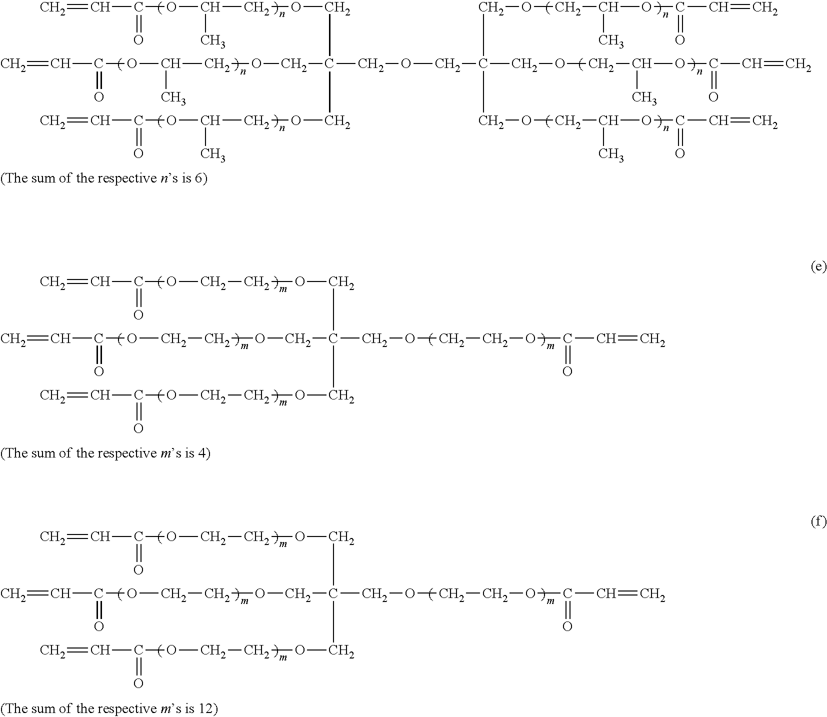

Examples of commercially available products of the polymerizable compounds represented by Formulae (Z-4) and (Z-5) include SR-494 which is tetrafunctional acrylate having four ethyleneoxy chains manufactured by Sartomer, DPCA-60 which is a hexafunctional acrylate having six pentyleneoxy chains manufactured by Nippon Kayaku Co., Ltd., and TPA-330 which is a trifunctional acrylate having three isobutylene oxy chains.

As the polymerizable compound, urethane acrylates disclosed in JP1973-41708B (JP-S48-41708B), JP1976-37193A (JP-S51-37193A), JP1990-32293B (JP-H02-32293B), and JP1990-16765B (JP-H02-16765B), and urethane compounds having an ethylene oxide-based skeleton disclosed in JP1983-49860B (JP-S58-49860B), JP1981-17654B (JP-S56-17654B), JP1987-39417B (JP-S62-39417B), and JP1987-39418B (JP-S62-39418B) are preferable. Addition polymerizable compounds having an amino structure or a sulfide structure in a molecule which are disclosed in JP1988-277653A (JP-S63-277653A), JP1988-260909A (JP-S63-260909A), and JP1989-105238A (JP-H01-105238A) are also preferable.

Examples of commercially available products of polymerizable compounds include a urethane oligomer UAS-10 and UAB-140 (manufactured by Nippon Paper Industries Co., Ltd.), U-4HA, U-6LPA, UA-32P, U-10HA, U-10PA, UA-122P, UA-1100H, UA-7200 (manufactured by Shin-Nakamura Chemical Co., Ltd.), DPHA-40H (manufactured by Nippon Kayaku Co., Ltd.), UA-306H, UA-306T, UA-306I, AH-600, T-600, and AI-600 (manufactured by Kyoeisha Chemical Co., Ltd.), and UA-9050 and UA-9048 (manufactured by BASF SE).

With respect to these polymerizable compounds, the details of the using method thereof such as the structure, the single use, the combination use, and the addition amount may be optionally set according to the final performance design of the composition. For example, in view of sensitivity, a structure in which a content of the unsaturated groups per molecule is high is preferable, and a difunctional or higher functional group is preferable in many cases. In view of increasing the strength of the formed body, a trifunctional or higher functional polymerizable compound is preferable. It is also preferable to use compounds of which the numbers of functional groups and the kinds are different. It is also preferable that polymerizable compounds which are trifunctional or higher functional and which have different ethylene oxide chain lengths are used in combination. With respect to the compatibility with other components included in the composition (for example, a photopolymerization initiator or a resin) and dispersibility, the selection and/or the use of the polymerizable compound is a preferable factor, and the compatibility and the like can be improved by using low purity compounds or two or more kinds thereof in combination.

The content of the polymerizable compound is preferably 1 to 80 mass % with respect to the total solid content of the composition. The lower limit is preferably 3 mass % or more and more preferably 5 mass % or more. The upper limit is more preferably 70 mass % or less and even more preferably 60 mass % or less.

(Compound Having Epoxy Group)

According to the present invention, a compound having an epoxy group can be used as the curable compound. Examples of the compound having an epoxy group include a compound having one or more epoxy groups in one molecule, and a compound having two or more epoxy groups is preferable. It is preferable that 1 to 100 epoxy groups are included in one molecule. For example, the upper limit can be 10 or less and can be 5 or less. The lower limit is preferably 2 or more.

With respect to the compound having an epoxy group, the epoxy equivalent (=molecular weight of compound having epoxy group/the number of epoxy groups) is preferably 500 g/equivalent or less, more preferably 100 to 400 g/equivalent, and even more preferably 100 to 300 g/equivalent.

The compound having an epoxy group may be any one of a low molecule compound (for example, having molecular weight of less than 1,000) and a high molecule compound (macromolecule) (for example, having a molecular weight of 1,000 or more, in a case of a polymer, having a weight-average molecular weight of 1,000 or more). The weight-average molecular weight of the compound having an epoxy group is preferably 200 to 100,000 and more preferably 500 to 50,000. The upper limit of the weight-average molecular weight is preferably 10,000 or less, more preferably 5,000 or less, and even more preferably 3,000 or less.

As the compound having an epoxy group, compounds disclosed in paragraphs 0034 to 0036 of JP2013-011869A, paragraphs 0147 to 0156 of JP2014-043556A, and paragraphs 0085 to 0092 of JP2014-089408A can be used. The contents thereof are incorporated into the present specification. As the commercially available product, examples of the bisphenol A type epoxy resin include jER825, jER827, jER828, jER834, jER1001, jER1002, jER1003, jER1055, jER1007, jER1009, and jER1010 (above are manufactured by Mitsubishi Chemical Corporation), and EPICLON860, EPICLON1050, EPICLON1051, and EPICLON1055 (above are manufactured by DIC Corporation), examples of the bisphenol F type epoxy resin include jER806, jER807, jER4004, jER4005, jER4007, and jER4010 (above are manufactured by Mitsubishi Chemical Corporation), EPICLON830 and EPICLON835 (above are manufactured by DIC Corporation), and LCE-21 and RE-602S (above are manufactured by Nippon Kayaku Co., Ltd.), examples of the phenol novolak type epoxy resin include jER152, jER154, jER157S70, and jER157S65 (above are manufactured by Mitsubishi Chemical Corporation), and EPICLON N-740, EPICLON N-770, and EPICLON N-775 (above are manufactured by DIC Corporation), examples of the cresol novolak type epoxy resin include EPICLON N-660, EPICLON N-665, EPICLON N-670, EPICLON N-673, EPICLON N-680, EPICLON N-690, and EPICLON N-695 (above are manufactured by DIC Corporation), and EOCN-1020 (manufactured by Nippon Kayaku Co., Ltd.), and examples of the aliphatic epoxy resin include ADEKA RESIN EP-4080S, ADEKA RESIN EP-4085S, and ADEKA RESIN EP-4088S (manufactured by ADEKA Corporation), CELLOXIDE 2021P, CELLOXIDE 2081, CELLOXIDE 2083, CELLOXIDE 2085, EHPE3150, EPOLEAD PB 3600, and EPOLEAD PB 4700 (above are manufactured by Daicel Corporation), and DENACOL EX-212L, EX-214L, EX-216L, EX-321L, and EX-850L (above are manufactured by Nagase ChemteX Corporation). In addition, examples thereof include ADEKA RESIN EP-4000S, ADEKA RESIN EP-4003S, ADEKA RESIN EP-4010S, and ADEKA RESIN EP-4011S (above are manufactured by ADEKA Corporation), NC-2000, NC-3000, NC-7300, XD-1000, EPPN-501, and EPPN-502 (above are manufactured by ADEKA Corporation), and jER1031S (manufactured by Mitsubishi Chemical Corporation).

As the compound having an epoxy group, compounds disclosed in paragraph 0045 of JP2009-265518A can be used. The content thereof is incorporated into the present specification.

The content of the compound having an epoxy group is preferably 1 to 80 mass % with respect to the total solid content of the composition. The lower limit is preferably 3 mass % or more and more preferably 5 mass % or more. The upper limit is preferably 70 mass % or less and more preferably 60 mass % or less. The compound having an epoxy group may be used singly or two or more kinds thereof may be used in combination. In a case where two or more kinds thereof are used, it is preferable that the total amount thereof is in the above range.

<<Photopolymerization Initiator>>

The composition of the present invention can contain a photopolymerization initiator. Particularly, in a case where the composition includes a polymerizable compound, it is preferable that the photopolymerization initiator is contained. The photopolymerization initiator is not particularly limited, and the photopolymerization initiator can be selected from well-known photopolymerization initiators. For example, a photopolymerization initiator having photosensitivity to light from the ultraviolet range to the visible range is preferable. The photopolymerization initiator is preferably a photo radical polymerization initiator. The photopolymerization initiator preferably contains at least one compound having a molar light absorption coefficient of at least about 50 in the range of about 300 nm to 800 nm (more preferably 330 nm to 500 nm).

Examples of the photopolymerization initiator include a halogenated hydrocarbon derivative (for example, a derivative having a triazine skeleton or a derivative having an oxadiazole skeleton), an acylphosphine compound such as acylphosphine oxide, hexaarylbiimidazole, an oxime compound such as an oxime derivative, organic peroxide, a thio compound, a ketone compound, aromatic onium salt, keto oxime ether, an aminoacetophenone compound, and hydroxyacetophenone. Examples of the halogenated hydrocarbon compound having a triazine skeleton include compounds disclosed in Bull. Chem. Soc. Japan, 42, 2924 (1969) written by Wakabayashi et al., compounds disclosed in GB1388492B, compounds disclosed in JP1978-133428A (JP-553-133428A), compounds disclosed in DE3337024B, compounds disclosed in J. Org. Chem.; 29, 1527 (1964) written by F. C. Schaefer et al., compounds disclosed in JP1987-58241A (JP-562-58241A), compounds disclosed in JP1993-281728A (JP-H05-281728A), compounds disclosed in JP1993-34920A (JP-H05-34920A), and compounds disclosed in US4212976A.

In view of exposure sensitivity, a compound selected from the group consisting of a trihalomethyl triazine compound, a benzyl dimethyl ketal compound, an α-hydroxy ketone compound, an α-aminoketone compound, an acylphosphine compound, a phosphine oxide compound, a metallocene compound, an oxime compound, a triallyl imidazole dimer, an onium compound, a benzothiazole compound, a benzophenone compound, an acetophenone compound and derivatives thereof, a cyclopentadiene-benzene-iron complex and a salt thereof, a halomethyl oxadiazole compound, and a 3-aryl-substituted coumarin compound is preferable.

As the photopolymerization initiator, a hydroxyacetophenone compound, an aminoacetophenone compound, and an acylphosphine compound may also be suitably used. More specifically, for example, aminoacetophenone-based initiators disclosed in JP1998-291969A (JP-H10-291969A) and acylphosphine-based initiators disclosed in JP4225898B can also be used. As the hydroxyacetophenone-based initiator, IRGACURE 184, DAROCUR 1173, IRGACURE 500, IRGACURE 2959, and IRGACURE 127 (trade names: all manufactured by BASF SE) can be used. As the aminoacetophenone-based initiator, IRGACURE 907, IRGACURE 369, IRGACURE 379, and IRGACURE 379EG (trade name, all manufactured by BASF SE) which are commercially available products can be used. As the aminoacetophenone-based initiator, compounds disclosed in JP2009-191179A, in which the absorption wavelength is matched to a long wave light source of 365 nm, 405 nm, or the like, can also be used.

As the acylphosphine-based initiator, IRGACURE 819 or IRGACURE TPO (trade name: all manufactured by BASF SE) which are commercially available products can be used.

In view of prevention of coloration after exposure, an acylphosphine-based initiator is preferable.

As the photopolymerization initiator, an oxime compound can also be suitably used. Specific examples of the oxime compound include compounds disclosed in JP2001-233842A, compounds disclosed in JP2000-80068A, compounds disclosed in JP2006-342166A, and compounds disclosed in JP2016-21012A.

According to the present invention, examples of the oxime compound that can be preferably used include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropane-1-one, 2-benzoyloxyimino-1-phenylpropan-1-one, 3-(4-toluenesulfonyloxy)iminobutan-2-one, and 2-ethoxycarbonyloxyimino-1-phenylpropan-1-one. Examples thereof also include compounds disclosed in J. C. S. Perkin II (1979) pp. 1653 to 1660, J. C. S. Perkin II (1979) pp. 156 to 162, Journal of Photopolymer Science and Technology (1995) pp. 202 to 232 and JP2000-66385A, compounds disclosed in JP2000-80068A, JP2004-534797A, and JP2006-342166A. As commercially available products, IRGACURE OXE01, IRGACURE OXE02, IRGACURE OXE03, and IRGACURE OXE04 (above are manufactured by BASF SE) are preferably used. TR-PBG-304 (manufactured by Changzhou Tronly New Electronic Materials Co., Ltd.), and ADEKA ARKLES NCI-930 and ADEKA OPTOMER N-1919 (photopolymerization initiator 2 of JP2012-14052A) (manufactured by ADEKA Corporation) can also be used.

As the oxime compounds other than those described above, compounds disclosed in JP2009-519904A in which oxime is linked to an N position of carbazole, compounds disclosed in U.S. Pat. No. 7,626,957B in which a hetero substituent is introduced into a benzophenone moiety, compounds disclosed in JP2010-15025A and US2009-292039A in which a nitro group is introduced at a coloring agent moiety, a ketoxime compound disclosed in WO2009/131189A, compounds disclosed in U.S. Pat. No. 7,556,910B in which a triazine skeleton and an oxime skeleton are contained in the same molecule, a compound disclosed in JP2009-221114A which has an absorption maximum at 405 nm and has satisfactory sensitivity to a g-line light source, and compounds disclosed in paragraphs 0076 to 0079 of JP2014-137466A.

Preferably, for example, paragraphs 0274 to 0275 of JP2013-29760A can be referred to, and the content thereof is incorporated into the present specification.

Specifically, as the oxime compound, a compound represented by Formula (OX-1) is preferable. With respect to the oxime compound, an N—O bond of the oxime may be an oxime compound of the (E) isomer, and the N—O bond of oxime may be an oxime compound of the (Z) isomer or may be a mixture of (E) isomer and (Z) isomer.

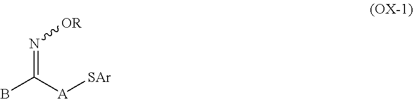

In Formula (OX-1), R and B each independently represent a monovalent substituent, A represents a divalent organic group, and Ar represents an aryl group.

In Formula (OX-1), as the monovalent substituent represented by R, a monovalent nonmetallic atomic group is preferable.

Examples of the monovalent nonmetallic atomic group include an alkyl group, an aryl group, an acyl group, an alkoxycarbonyl group, an aryloxycarbonyl group, a heterocyclic group, an alkylthiocarbonyl group, and an arylthiocarbonyl group. These groups may have one or more substituents. The substituent described above may be further substituted with another substituent.

Examples of the substituent include a halogen atom, an aryloxy group, an alkoxycarbonyl group, an aryloxycarbonyl group, an acyloxy group, an acyl group, an alkyl group, and an aryl group.

In Formula (OX-1), as the monovalent substituent represented by B, an aryl group, a heterocyclic group, an arylcarbonyl group, or a heterocyclic carbonyl group is preferable. These groups may have one or more substituents. Examples of the substituent include the substituents described above.

In Formula (OX-1), the divalent organic group represented by A is preferably an alkylene group having 1 to 12 carbon atoms, a cycloalkylene group, or an alkynylene group. These groups may have one or more substituents. Examples of the substituent include substituents described above.

According to the present invention, as the photopolymerization initiator, an oxime compound having a fluorene ring can also be used. Specific examples of the oxime compound having a fluorene ring include compounds disclosed in JP2014-137466A. The content thereof is incorporated into the present specification.

According to the present invention, as the photopolymerization initiator, an oxime compound having a fluorine atom can also be used. Specific examples of the oxime compound having a fluorine atom include compounds disclosed in JP2010-262028A, compounds 24 and 36 to 40 disclosed in JP2014-500852A, and Compound (C-3) of JP2013-164471A. The contents thereof are incorporated into the present specification.

According to the present invention, as the photopolymerization initiator, an oxime compound having a nitro group can be used. The oxime compound having a nitro group is also preferably a dimer. Specific examples of the oxime compound having a nitro group include compounds disclosed in paragraphs 0031 to 0047 JP2013-114249A and paragraphs 0008 to 0012 and 0070 to 0079 of JP2014-137466A, compounds disclosed in paragraphs 0007 to 0025 JP4223071B, and ADEKA ARKLES NCI-831 (manufactured by ADEKA Corporation).

Specific examples of the oxime compound that is preferably used in the present invention are provided below, and the present invention is not limited.

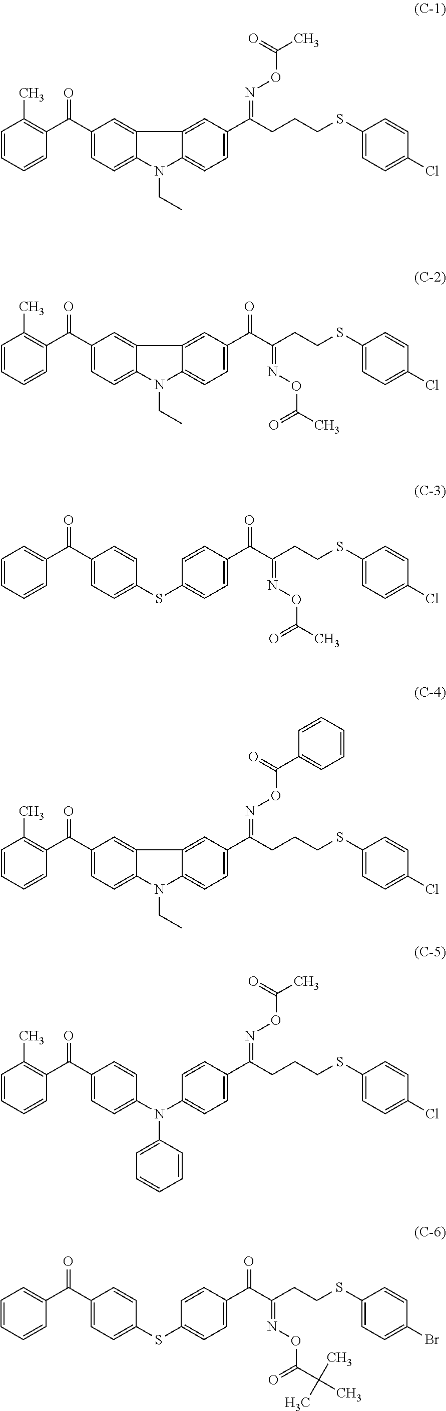 [SMILES: CCn1c2ccc(C(=O)c3ccccc3C)cc2c2cc(/C(CCCSc3ccc(Cl)cc3)=N/OC(C)=O)ccc21 ; CCn1c2ccc(C(=O)/C(CCSc3ccc(Cl)cc3)=N/OC(C)=O)cc2c2cc(C(=O)c3ccccc3C)ccc21 ; CC(=O)O/N=C(\CCSc1ccc(Cl)cc1)C(=O)c1ccc(Sc2ccc(C(=O)c3ccccc3)cc2)cc1 ; CCn1c2ccc(C(=O)c3ccccc3C)cc2c2cc(/C(CCCSc3ccc(Cl)cc3)=N/OC(=O)c3ccccc3)ccc21 ; CC(=O)O/N=C(\CCCSc1ccc(Cl)cc1)c1ccc(N(c2ccccc2)c2ccc(C(=O)c3ccccc3C)cc2)cc1 ; CC(C)(C)C(=O)O/N=C(\CCSc1ccc(Br)cc1)C(=O)c1ccc(Sc2ccc(C(=O)c3ccccc3)cc2)cc1]

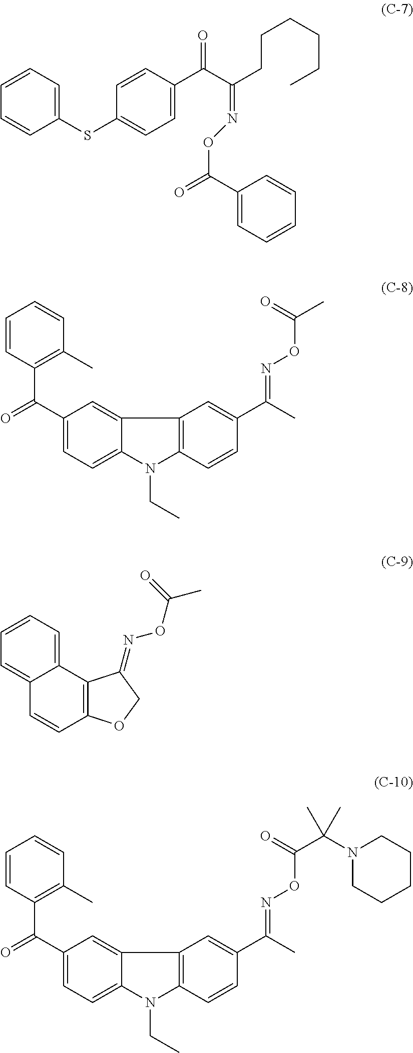 [SMILES: CCCCCC/C(=N/OC(=O)c1ccccc1)C(=O)c1ccc(Sc2ccccc2)cc1 ; CCn1c2ccc(C(=O)c3ccccc3C)cc2c2cc(/C(C)=N/OC(C)=O)ccc21 ; CC(=O)O/N=C1\COc2ccc3ccccc3c21 ; CCn1c2ccc(C(=O)c3ccccc3C)cc2c2cc(/C(C)=N/OC(=O)C(C)(C)N3CCCCC3)ccc21]

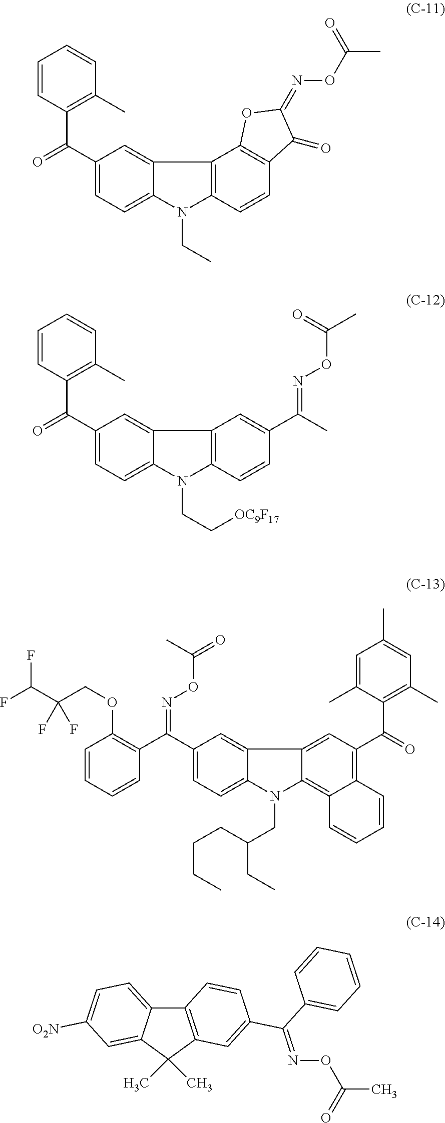

The oxime compound is preferably a compound having a maximum absorption wavelength in the wavelength range of 350 nm to 500 nm, more preferably a compound having an absorption wavelength in the wavelength range of 360 nm to 480 nm, and particularly preferably a compound with high absorbance at 365 nm and 405 nm.

In view of sensitivity, with respect to the oxime compound, a molar light absorption coefficient at 365 nm or 405 nm is preferably 1,000 to 300,000, more preferably 2,000 to 300,000, and particularly preferably 5,000 to 200,000. In the measuring of the molar light absorption coefficient of the compound, well-known methods can be used, but, specifically, for example, the molar light absorption coefficient is preferably measured at a concentration of 0.01 g/L by using an ethyl acetate solvent with an ultraviolet-visible spectrophotometer (manufactured by Varian Inc., Cary-5 spectrophotometer).

The content of the photopolymerization initiator is preferably 0.1 to 50 mass %, more preferably 0.5 to 30 mass %, and even more preferably 1 to 20 mass % with respect to the total solid content of the composition. In this range, better sensitivity and pattern formability can be obtained. The composition may include the photopolymerization initiator singly or may include two or more kinds thereof. In a case where two or more kinds thereof are contained, the total amount thereof is preferably in the above range.

<<Antioxidant>>

The composition of the present invention preferably contains an antioxidant. Examples of the antioxidant include a phenol compound, a phosphite compound, and a thioether compound, and a phenol compound having a molecular weight of 500 or more or a phosphite compound having a molecular weight of 500 or more is preferable, or a thioether compound having a molecular weight of 500 or more. The antioxidant is preferably a phenol compound and more preferably a phenol compound having a molecular weight of 500 or more. The antioxidant may function as a polymerization inhibitor.

As the phenol compound, any phenol compound known as a phenol-based antioxidant can be used. Preferable examples of the phenol compound include a hindered phenol compound. Particularly, a compound having a substituent at a site (ortho position) adjacent to the phenolic hydroxy group is preferable. As the substituent described above, a substituted or unsubstituted alkyl group having 1 to 22 carbon atoms is preferable, and a methyl group, an ethyl group, a propyl group, an isopropyl group, a butyl group, an isobutyl group, a t-butyl group, a pentyl group, an isopentyl group, a t-pentyl group, a hexyl group, an octyl group, an isooctyl group, and a 2-ethylhexyl group is more preferable. A compound having a phenol group and a phosphorus acid ester group in the same molecule is also preferable.

The phenol compound is preferably a polysubstituted phenolic compound. The polysubstituted phenolic compounds are largely divided into three types ((A) hindered type, (B) semi-hindered type, and (C) less hindered type) of which substitution positions and structures are different.

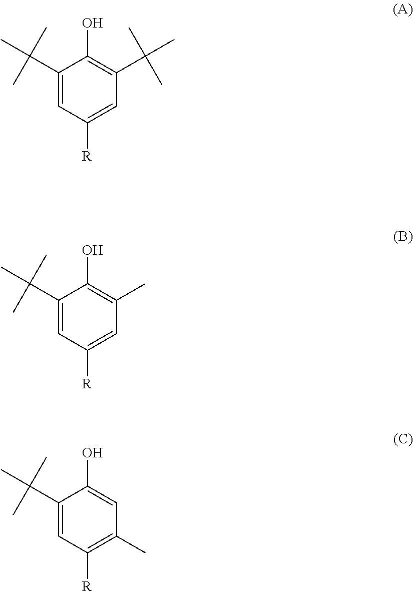

In Formulae (A) to (C), R is a substituent, examples thereof include a hydrogen atom, a halogen atom, an amino group which may have a substituent, an alkyl group which may have a substituent, an aryl group which may have a substituent, an alkoxy group which may have a substituent, an aryloxy group which may have a substituent, an alkylamino group which may have a substituent, an arylamino group which may have a substituent, an alkylsulfonyl group which may have a substituent, and an arylsulfonyl group which may have a substituent. Among these, an amino group which may have a substituent, an alkyl group which may have a substituent, an aryl group which may have a substituent, an alkoxy group which may have a substituent, an aryloxy group which may have a substituent, an alkylamino group which may have a substituent, and an arylamino group which may have a substituent are preferable.

The phenol compound is preferably a compound in which a plurality of structures represented by Formulae (A) to (C) are present in the same molecule and more preferably a compound in which two to four structures represented by the Formulae (A) to (C) are present in the same molecule.

Examples of the phenol compound include a compound selected from the group consisting of p-methoxyphenol, di-tert-butyl-p-cresol, pyrogallol, tert-butyl catechol, 4,4-thiobis(3-methyl-6-tert-butylphenol), 2,2′-methylenebis(4-methyl-6-t-butylphenol), phenolic resins, and cresol resins.

As the representative examples that can be obtained as commercially available products, examples of (A) include Sumilizer BHT (manufactured by Sumitomo Chemical Company Limited), Irganox 1010 and 1222 (manufactured by BASF SE), ADEKASTAB AO-20, AO-50, AO-50F, AO-60, AO-60G, and AO-330 (manufactured by ADEKA Corporation), examples of (B) include Sumilizer BBM-S(manufactured by Sumitomo Chemical Company Limited), Irganox 245 (manufactured by BASF SE), and ADEKASTAB AO-80 (manufactured by ADEKA Corporation), and examples of (C) include ADEKASTAB AO-30 and AO-40 (manufactured by ADEKA Corporation).

Examples of the phosphite compound include at least one compound selected from the group consisting of tris[2-[[2,4,8,10-tetrakis(1,1-dimethylethyl)dibenzo[d,f][1,3,2]dioxaphosphepin-6-yl]oxy]ethyl]amine, tris[2-[(4,6,9,11-tetra-tert-butyldibenzo[d,f][1,3,2]dioxaphosphepin-2-yl)oxy]ethyl], and ethylbis(2,4-di-tert-butyl-6-methylphenyl)phosphite.

In addition to the above, ADEKASTAB PEP-36A and ADEKASTAB AO-4125 (ADEKA Corporation) and the like can also be used as the antioxidant.

The content of the antioxidant is preferably 0.01 to 20 mass % and more preferably 0.3 to 15 mass % with respect to the total solid content of the composition. The antioxidant may be used singly or two or more kinds thereof may be used. In a case where two or more kinds are used, it is preferable that the total amount thereof is in the above range.

<<Silane Coupling Agent>>

The composition of the present invention can contain a silane coupling agent. According to the present invention, the “silane coupling agent” means a silane compound having a hydrolyzable group and other functional group. The “hydrolyzable group” refers to a substituent which is directly connected to a silicon atom and can generate a siloxane bond by hydrolysis reaction and/or condensation reaction. Examples of the hydrolyzable group include a halogen atom, an alkoxy group, and an acyloxy group, and an alkoxy group is preferable. That is, the silane coupling agent is preferably a compound having an alkoxysilyl group. In addition, it is preferable that the functional group other than the hydrolyzable group has a group exhibiting affinity by interaction or bond formation with the resin. Examples thereof include a (meth)acryloyl group, a phenyl group, a mercapto group, an epoxy group, and an oxetanyl group, and a (meth)acryloyl group and an epoxy group are preferable. That is, the silane coupling agent is preferably a compound having an alkoxysilyl group and a (meth)acryloyl group and/or an epoxy group.

Specific examples of the silane coupling agent include 1,6-bis(trimethoxysilyl)hexane, trifluoropropyl trimethoxysilane, hexamethyldisilazane, vinyl trimethoxysilane, vinyl triethoxysilane, 2-(3,4-epoxycyclohexyl)ethyl trimethoxysilane, 3-glycidoxypropylmethyl dimethoxysilane, 3-glycidoxypropyl trimethoxysilane, 3-glycidoxypropylmethyl diethoxysilane, 3-glycidoxypropyl triethoxysilane, p-styryl trimethoxysilane, 3-methacryloxypropylmethyl dimethoxysilane, 3-methacryloxypropyl trimethoxysilane, 3-methacryloxypropylmethyl diethoxysilane, 3-methacryloxypropyl triethoxysilane, 3-acryloxypropyl trimethoxysilane, N-2-(aminomethylethyl)-3-aminopropylmethyl dimethoxysilane, N-2-(aminoethyl)-3-aminopropylmethyl dimethoxysilane, N-2-(aminoethyl)-3-aminopropyl trimethoxysilane, 3-aminopropyl trimethoxysilane, 3-aminopropyl triethoxysilane, 3-triethoxysilyl-N-(1,3-dimethyl-butylidene) propyl amine, N-phenyl-3-aminopropyl trimethoxysilane, hydrochloride of N-(vinylbenzyl)-2-aminoethyl-3-aminopropyl trimethoxysilane, tris(trimethoxysilylpropyl) isocyanurate, 3-ureidopropyl triethoxysilane, 3-mercaptopropylmethyl dimethoxy silane, 3-mercaptopropyl trimethoxysilane, bis(triethoxysilylpropyl)tetrasulfide, and 3-isocyanatepropyl triethoxysilane. In addition to the above, an alkoxy oligomer can be used. The following compounds can also be used.

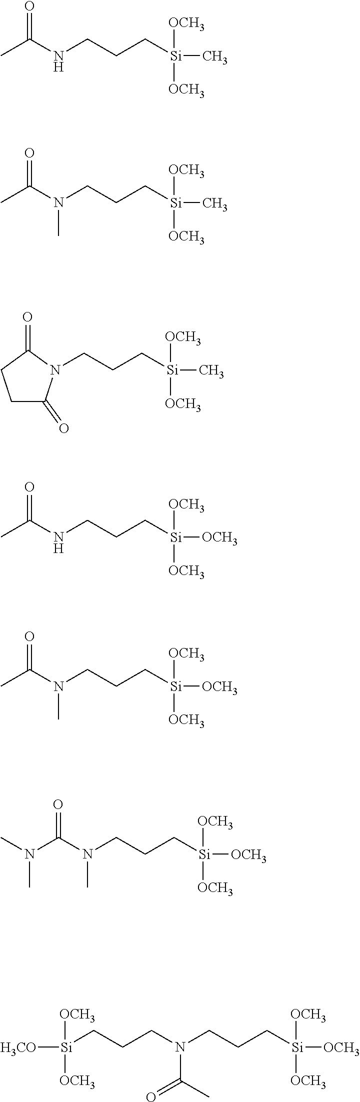

Examples of commercially available products include KBM-13, KBM-22, KBM-103, KBE-13, KBE-22, KBE-103, KBM-3033, KBE-3033, KBM-3063, KBM-3066, KBM-3086, KBE-3063, KBE-3083, KBM-3103, KBM-3066, KBM-7103, SZ-31, KPN-3504, KBM-1003, KBE-1003, KBM-303, KBM-402, KBM-403, KBE-402, KBE-403, KBM-1403, KBM-502, KBM-503, KBE-502, KBE-503, KBM-5103, KBM-602, KBM-603, KBM-903, KBE-903, KBE-9103, KBM-573, KBM-575, KBM-9659, KBE-585, KBM-802, KBM-803, KBE-846, KBE-9007, X-40-1053, X-41-1059A, X-41-1056, X-41-1805, X-41-1818, X-41-1810, X-40-2651, X-40-2655A, KR-513, KC-89S, KR-500, KR-516, KR-517, X-40-9296, X-40-9225, X-40-9246, X-40-9250, KR-401N, X-40-9227, X-40-9247, KR-510, KR-9218, KR-213, X-40-2308, and X-40-9238, which are manufactured by Shin-Etsu Chemical Co., Ltd. Examples of the silane coupling agent include compounds disclosed in paragraphs 0018 to 0036 of JP2009-288703A and compounds disclosed in paragraphs 0056 to 0066 of JP2009-242604A, and the contents thereof are incorporated into the present specification.

The content of the silane coupling agent is preferably 0.01 to 15.0 mass % and more preferably 0.05 to 10.0 mass % with respect to the total solid content of the composition. The silane coupling agent may be used singly or two or more kinds thereof may be used. In a case where two or more kinds thereof are used, the total amount thereof is preferably in the above range.

<<Sensitizer>>

The composition of the present invention may contain a sensitizer for the purpose of improving the radical generation efficiency of the photopolymerization initiator and increasing the wavelength of the photosensitive wavelength. As the sensitizer, it is preferable to sensitize the photopolymerization initiator with an electron moving mechanism or an energy moving mechanism. Examples of the sensitizer include a sensitizer having an absorption wavelength in the wavelength range of 300 nm to 450 nm. Specifically, the description of paragraph 0231 to 0253 (<0256> to <0273> of corresponding US2011/0124824A) of JP2010-106268A can be referred to, and the content thereof is incorporated into the present specification.

The content of the sensitizer is preferably 0.1 to 20 mass % and more preferably 0.5 to 15 mass % with respect to the total solid content of the composition. The sensitizer may be used singly or two or more kinds thereof may be used. In a case where two or more kinds thereof are used, the total amount thereof is preferably in the above range.

<<Co-Sensitizer>>

It is preferable that the composition of the present invention further contains a co-sensitizer. The co-sensitizer has an effect of further improving the sensitivity of the photopolymerization initiator and the sensitizer to actinic radiation or suppressing polymerization inhibition of the polymerizable compound. As the co-sensitizer, specifically, the description of paragraphs 0254 to 0257 (<0277> to <0279> of corresponding US2011/0124824A) of JP2010-106268A is referred to, and the content thereof is incorporated into the present specification.

In view of the improvement of the polymerization growth rate and the curing rate, the content of the co-sensitizer is preferably 0.1 to 30 mass %, more preferably 1 to 25 mass %, and even more preferably 1.5 to 20 mass % with respect to the total solid content of the composition. The co-sensitizer may be used singly, or two or more kinds thereof may be used. In a case where two or more kinds thereof are used, the total amount thereof is preferably in the above range.

<<Polymerization Inhibitor>>

In order to prevent unnecessary polymerization of a compound (for example, the polymerizable compound) having a group having an ethylenically unsaturated bond during the manufacturing or storage of the composition, it is preferable that a polymerization inhibitor is added to the composition of the present invention. Examples of the polymerization inhibitor include hydroquinone, p-methoxyphenol, di-tert-butyl-p-cresol, pyrogallol, tert-butyl catechol, benzoquinone, 4,4′-thiobis(3-methyl-6-tert-butylphenol), 2,2′-methylenebis(4-methyl-6-tert-butylphenol), and N-nitrosophenylhydroxy amine salt (ammonium salt, primary cerium salt, and the like). Among these, p-methoxyphenol is preferable. The polymerization inhibitor may function as an antioxidant.

The content of the polymerization inhibitor is preferably 0.01 parts by mass to 10 parts by mass, more preferably 0.01 to 8 parts by mass, and most preferably 0.01 to 5 parts by mass with respect to 100 parts by mass of the photopolymerization initiator.

<<Surfactant>>

In view of further improving coatability, the composition of the present invention may add various surfactants. As the surfactant, various kinds of surfactants such as a fluorine-based surfactant, a nonionic surfactant, a cationic surfactant, an anionic surfactant, and a silicone-based surfactant may be used.

Particularly, since the liquid properties (particularly, fluidity) in a case of being prepared as a coating liquid are further improved by causing the composition of the present invention to contain a fluorine-based surfactant, uniformity after coating or liquid saving properties can be further improved.

That is, in the case where a film is formed by using a coating liquid to which a composition containing a fluorine-based surfactant is applied, wettability to the surface to be coated is improved by reducing the interfacial tension between the surface to be coated and the coating liquid, such that the coatability on the surface to be coated is improved. Therefore, even in the case where a thin film of about several μm is formed with a small amount of liquid, it is effective in that it is possible to more suitably form a uniform thickness film with small thickness unevenness.

The fluorine content of the fluorine-based surfactant is preferably 3 to 40 mass %. The lower limit is preferably 5 mass % or more and more preferably 7 mass % or more. The upper limit is preferably 30 mass % or less and more preferably 25 mass % or less. In a case where the fluorine content is within the above range, the surfactant is effective in terms of the uniformity of the thickness of the coating film and liquid saving properties, and solubility is also satisfactory.

Specific examples of the fluorine-based surfactant include surfactants disclosed in paragraphs 0060 to 0064 (paragraphs 0060 to 0064 of WO2014/17669A) of JP2014-41318A and surfactants disclosed in paragraphs 0117 to 0132 of JP2011-132503A, and the contents thereof are incorporated into the present specification. Examples of commercially available products of the fluorine-based the surfactants include MEGAFACE F-171, MEGAFACE F-172, MEGAFACE F-173, MEGAFACE F-176, MEGAFACE F-177, MEGAFACE F-141, MEGAFACE F-142, MEGAFACE F-143, MEGAFACE F-144, MEGAFACE R 30, MEGAFACE F-437, MEGAFACE F-475, MEGAFACE F-479, MEGAFACE F-482, MEGAFACE F-554, and MEGAFACE F-780 (above are DIC Corporation), FLUORAD FC 430, FLUORAD FC 431, and FLUORAD FC 171 (above are Sumitomo 3M Limited), SURFLON S-382, SURFLON SC-101, SURFLON SC-103, SURFLON SC-104, SURFLON SC-105, SURFLON SC-1068, SURFLON SC-381, SURFLON SC-383, SURFLON S-393, and SURFLON KH-40 (above are Asahi Glass Co., Ltd.), PolyFox PF 636, PF656, PF 6320, PF 6520, and PF 7002 (above are OMNOVA Solutions Inc.). As the fluorine-based surfactant, compounds disclosed in paragraphs 0015 to 0158 of JP2015-117327A can be used. The following compounds can be used as the fluorine-based surfactant.

The fluorine-based surfactant is a molecular structure having a functional group containing a fluorine atom, and an acrylic compound in which a functional group is broken in a case where heat is applied and the fluorine atom volatilizes can also be suitably used. As the acrylic compound which has a molecular structure having a functional group containing a fluorine atom and in which a functional group is broken in a case where heat is applied and the fluorine atom volatilizes, MEGAFACE DS series manufactured by DIC Corporation (Japan Chemical Daily, Feb. 22, 2016) (Nikkei Sangyo Shimbun, Feb. 23, 2016), for example MEGAFACE DS-21 may be used.

As the fluorine-based surfactant, a block polymer can also be used. Examples thereof include compounds disclosed in JP2011-89090A. As the fluorine-based surfactant, a fluorine-containing polymer compound including a repeating unit derived from a (meth)acrylate compound having a fluorine atom and a repeating unit derived from a (meth)acrylate compound having two or more (preferably five or more) alkyleneoxy groups (preferably ethyleneoxy and propyleneoxy) can also be preferably used. The following compounds are also exemplified as the fluorine-based surfactant used in the present invention.

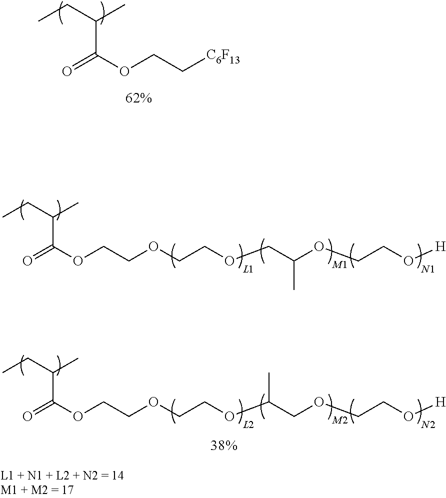

The weight-average molecular weight of the compound is preferably 3,000 to 50,000, and for example, 14,000. In the compound, % that indicates a proportion of the repeating unit is mass %.

As the fluorine-based surfactant, a fluorine-containing polymer having a group having an ethylenically unsaturated bond on a side chain can be used. Examples of the specific examples include compounds disclosed in paragraphs 0050 to 0090 and 0289 to 0295 of JP2010-164965A, for example, MEGAFACE RS-101, RS-102, RS-718K, and RS-72-K manufactured by DIC Corporation. As the fluorine-based surfactant, compounds disclosed in paragraphs 0015 to 0158 of JP2015-117327A can be used.

Examples of the nonionic surfactant include glycerol, trimethylolpropane, trimethylol ethane, and ethoxylate and propoxylate thereof (for example, glycerol propoxylate and glycerin ethoxylate), polyoxyethylene lauryl ether, polyoxyethylene stearyl ether, polyoxyethylene oleyl ether, polyoxyethylene octyl phenyl ether, polyoxyethylene nonylphenyl ether, polyethylene glycol dilaurate, polyethylene glycol distearate, and sorbitan fatty acid ester (PLURONIC L10, L31, L61, L62, 10R5, 17R2, and 25R2, TETRONIC 304, 701, 704, 901, 904, and 150R1 manufactured by BASF SE), PIONIN D-6512, D-6414, D-6112, D-6115, D-6120, D-6131, D-6108-W, D-6112-W, D-6115-W, D-6115-X, and D-6120-X (manufactured by Takemoto Oil & Fat Co., Ltd.).

Examples of the cationic surfactant include organosiloxane polymer KP341 (manufactured by Shin-Etsu Chemical Co., Ltd.), a (meth)acrylic acid-based (co)polymer POLYFLOW Nos. 75, 90, and 95 (manufactured by Kyoeisha Chemical Co., Ltd.), and W001 (manufactured by Yusho Co., Ltd.).

Examples of the anionic surfactant include W004, W005, and W017 (manufactured by Yusho Co., Ltd.).

Examples of the silicone-based surfactant include “TORAY SILICONE DC3PA”, “TORAY SILICONE SH7PA”, “TORAY SILICONE DC11PA”, “TORAY SILICONE SH21PA”, “TORAY SILICONE SH28PA”, “TORAY SILICONE SH29PA”, “TORAY SILICONE SH30PA”, and “TORAY SILICONE SH8400” manufactured by Dow Corning Toray Co., Ltd., “TSF-4440”, “TSF-4300”, “TSF-4445”, “TSF-4460”, and “TSF-4452” manufactured by Momentive Performance Materials Co., Ltd., “KP 341”, “KF 6001”, “KF 6002” manufactured by Shin-Etsu Silicone Co., Ltd., and “BYK 307”, “BYK 323”, and “BYK 330” manufactured by BYK Japan K.K.

The content of the surfactant is preferably 0.001 mass % to 5.0 mass % and more preferably 0.005 to 3.0 mass % with respect to the total solid content of the composition. The surfactant may be used singly or two or more kinds thereof may be used. In a case where two or more kinds thereof are used, the total amount thereof is preferably in the above range.

<<Ultraviolet Absorbing Agent>>

The composition of the present invention may contain an ultraviolet absorbing agent. The ultraviolet absorbing agent is preferably a conjugated diene-based compound and more preferably a compound represented by Formula (UV).

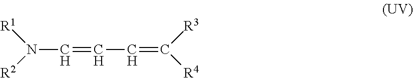

In Formula (UV), R¹ and R² each independently represent a hydrogen atom, an alkyl group having 1 to 20 carbon atoms, or an aryl group having 6 to 20 carbon atoms, and R¹ and R² may be identical to or different from each other, but the both do not represent hydrogen atoms at the same time.

R¹ and R² may form a cyclic amino group together with a nitrogen atom to which R¹ and R² are bonded. Examples of the cyclic amino group include a piperidino group, a morpholino group, a pyrrolidino group, a hexahydroazepino group, and a piperazino group.

R¹ and R² each independently represent preferably an alkyl group having 1 to 20 carbon atoms, more preferably an alkyl group having 1 to 10 carbon atoms, and even more preferably an alkyl group having 1 to 5 carbon atoms.

R³ and R⁴ represent an electron withdrawing group. Here, the electron withdrawing group is an electron withdrawing group having a Hammett's substituent constant σₚ value (hereinafter simply referred to as “σₚ value”) of 0.20 to 1.0. The electron withdrawing group is preferably an electron withdrawing group having the σₚ value of 0.30 to 0.8. R³ and R⁴ may be bonded to each other to form a ring. R³ and R⁴ are preferably an acyl group, a carbamoyl group, an alkyloxycarbonyl group, an aryloxycarbonyl group, a cyano group, a nitro group, an alkylsulfonyl group, an arylsulfonyl group, a sulfonyloxy group, and a sulfamoyl group, and more preferably an acyl group, a carbamoyl group, an alkyloxycarbonyl group, an aryloxycarbonyl group, a cyano group, an alkylsulfonyl group, an arylsulfonyl group, a sulfonyloxy group, and a sulfamoyl group.

At least one of R¹, R², R³, and R⁴ described above may have a form of a polymer derived from a monomer bonded to a vinyl group via a linking group. R1, R2, R3, and R4 may be a copolymer with another monomer.

Examples of the specific examples of the ultraviolet absorbing agent represented by Formula (UV) include the following compounds. As the description of the substituent of the ultraviolet absorbing agent represented by Formula (UV), the disclosure of paragraphs 0024 to 0033 (<0040> to <0059> of corresponding US2011/0039195A) of WO2009/123109A can be referred to, and the content thereof is incorporated into the present specification. As the preferable specific examples of the compound represented by Formula (I), the disclosure of example compounds (1) to (14) of paragraphs 0034 to 0037 (<0060> of corresponding US2011/0039195A) of WO2009/123109A can be referred to, and the content thereof is incorporated into the present specification.

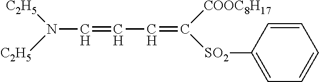

Examples of commercially available products of the ultraviolet absorbing agent include UV503 (manufactured by Daito Chemical Co., Ltd.). As the ultraviolet absorbing agent, an ultraviolet absorbing agent such as an aminodiene-based compound, a salicylate-based compound, a benzophenone-based compound, a benzotriazole-based compound, an acrylonitrile-based compound, and a triazine-based compound can be used. Specific examples thereof include compounds disclosed in JP2013-68814A. As the benzotriazole-based compound, MYUA series (Japan Chemical Daily, Feb. 1, 2016) manufactured by Miyoshi Oils and Fats Co., Ltd. may be used.

The content of the ultraviolet absorbing agent is preferably 0.1 to 10 mass %, more preferably 0.1 to 5 mass %, and particularly preferably 0.1 to 3 mass % with respect to the total solid content of the composition. According to the present invention, the ultraviolet absorbing agent may be used singly or two or more kinds thereof may be used. In a case where two or more kinds thereof are used, the total amount thereof is preferably in the above range.

<<Other Additives>>

The composition of the present invention can contain well-known additives such as a plasticizer and a greasing agent. Examples of the plasticizer include dioctyl phthalate, didodecyl phthalate, triethylene glycol dicaprylate, dimethyl glycol phthalate, tricresyl phosphate, dioctyl adipate, dibutyl sebacate, and triacetylglycerin. The content of the plasticizer is preferably 10 mass % or less with respect to the total mass of the curable compound and the resin.

The composition of the present invention can contain a colorant. The colorant may be a pigment or a dye. The content of the colorant is preferably 0.1 to 70 mass %, more preferably 1 to 50 mass %, and even more preferably 10 to 40 mass % with respect to the total solid content of the composition. The colorant may be used singly or two or more kinds thereof may be used. In a case where two or more kinds thereof are used, the total amount thereof is preferably in the above range. The composition of the present invention may not contain a colorant substantially. In the expression “not containing a colorant substantially”, the content is preferably 0.1 mass % or less and more preferably 0.05 mass % or less with respect to the total solid content of the composition, and it is even more preferable that a colorant is not contained.

<<Method of Preparing Far Infrared Ray Transmitting Composition>>

The far infrared ray transmitting composition of the present invention can be prepared by mixing the above component.

In a case of preparing the far infrared ray transmitting composition, the respective components are collectively formulated, or sequentially formulated after the respective components are dissolved or dispersed in a solvent. The order of introduction and the working conditions for formulation are not particularly limited.

For example, it is possible to prepare a far infrared ray transmitting composition by dispersing a high refractive index particle in a medium (preferably a solvent and a resin) to prepare a dispersion liquid and mixing the obtained dispersion liquid and other components (for example, a binder or a curable compound).

Examples of the process in which the high refractive index particle is dispersed include a process using compression, squeezing, impact, shearing, cavitation, or the like, as the mechanical force used for dispersing the high refractive index particles. Specific examples of the process include a beads mill, a sand mill, a roll mill, a ball mill, a paint shaker, a micro fluidizer, a high speed impeller, a sand grinder, a flow jet mixer, high pressure wet atomization, and ultrasonic dispersion. In pulverizing the high refractive index particles in the sand mill (beads mill), it is preferable to perform a treatment under the condition of increasing the pulverization efficiency by using beads with a small diameter, increasing a filling rate of the beads, or the like. It is also preferable to remove the coarse particles by filtration, centrifugation or the like after the pulverization treatment. Processes and dispersing machines disclosed in “Complete work on dispersion technology, Johokiko Co., Ltd., Jul. 15, 2005” or “Actual comprehensive data collection on dispersion technology and industrial application centered on suspension (solid/liquid dispersion system), Publishing department of Management Development Center, Oct. 10, 1978”, and paragraph 0022 of JP2015-157893A can be suitably used. In the process of dispersing the high refractive index particles, fine processing in the salt milling process may be performed. For materials, equipment, processing conditions and the like used in the salt milling process, those disclosed in, for example, JP2015-194521A and JP2012-046629A can be used.

In preparing the far infrared ray transmitting composition, it is preferable to filtrate the composition after mixing respective components with a filter for the purpose of removing foreign matters and reducing defects. The filter can be used without any particular limitation as long as the filter is used in the related art for filtration purposes and the like. Examples thereof include a filter using a fluororesin such as polytetrafluoroethylene (PTFE), a polyamide resin such as nylon (for example, nylon-6 and nylon-6,6), and a polyolefin resin such as polyethylene and polypropylene (PP) (high density and ultra high molecular weight). Among these materials, polypropylene (including high density polypropylene) and nylon are preferable.

The hole diameter of the filter is suitably about 0.01 to 7.0 μm, preferably about 0.01 to 3.0 μm, and more preferably about 0.05 to 0.5 μm. Within this range, it is possible to securely remove a fine foreign matter. It is also preferable to use a fibrous filter material, examples of the filter material include a polypropylene fiber, a nylon fiber, and a glass fiber. Specifically, a filter cartridge of SBP type series (SBP008 and the like) TPR type series (TPR002, TPR005, and the like), and SHPX type series (SHPX003 etc.) manufactured by Roki Techno Co., Ltd. can be used.

In a case where a filter is used, different filters may be combined. In this case, filtration with the first filter may be performed only once, or may be performed twice or more.

It is also possible to combine first filters having different hole diameters within the above range. Here, as the hole diameters, nominal values of the filter manufacturer can be referred to. As commercially available filters, for example, a filter can be selected from various filters provided by Nihon Pall Ltd. (DFA 4201 NXEY, and the like), Advantec Toyo Kaisha, Ltd., Entegris Japan Co., Ltd. (formerly Japan Mykrolis Corporation), or Kitz Micro Filter Corporation.

As the second filter, a filter formed of the same material as the first filter described above can be used.

For example, the filtration with the first filter may be performed only with the dispersion liquid, and the second filtration may be performed after mixing other components.

<<Application of Far Infrared Ray Transmitting Composition>>

The far infrared ray transmitting composition of the present invention can be preferably used in a far infrared ray transmitting filter or the like. Specifically, the far infrared ray transmitting composition can be preferably used for a far infrared ray transmitting filter or the like which transmits far infrared rays in a wavelength range of 1 to 14 μm (preferably a wavelength range of 3 to 5 or 8 to 12 μm). More specifically, the far infrared ray transmitting composition can be preferably used for a far infrared ray transmitting filter used for inspection equipment and a sensor using far infrared rays, a far infrared ray transmitting filter used for a sensor using far infrared rays such as current collecting sensors, and a substrate material for measuring far infrared transmittance. Further, the far infrared ray transmitting composition of the present invention can also be used as an antireflection film.

The far infrared ray transmitting composition of the present invention can be applied to a substrate by a method such as coating and a formed body having excellent far infrared ray transmitting properties can be manufactured by using various forming methods such as injection, pressing, and extrusion. The formed body can be manufactured by using a well-known ceramic manufacturing method. Specific examples thereof include a die press forming method, a rubber pressing method, an injection forming method, a slip casting method, and an extrusion forming method.

The far infrared ray transmitting composition of the present invention can be preferably used for a far infrared ray transmitting filter and the like that transmits far infrared rays in the wavelength range of 1 to 14 μm (preferably, in the wavelength range of 3 to 5 or 8 to 12 μm). The far infrared ray transmitting composition can also be used by being incorporated into an infrared camera or a solid-state imaging device.

The far infrared ray transmitting filter can be also formed only with a far infrared ray transmitting composition of the present invention. The far infrared ray transmitting composition of the present invention and another substrate can be combined so as to obtain a far infrared ray transmitting filter. For example, a laminate formed by applying the far infrared ray transmitting composition of the present invention to the substrate (for example, a Ge substrate or a Si substrate) is preferably used as the far infrared ray transmitting filter.

<Formed Body>

Subsequently, the formed body of the present invention is described below. The formed body of the present invention includes a particle (high refractive index particle) in which a refractive index is 1.3 to 5.0 at a wavelength of 10 μm. The lower limit of the refractive index of the high refractive index particle at a wavelength of 10 μm is preferably 1.35 or more and more preferably 1.4 or more. The upper limit is preferably 4.5 or less and more preferably 4.0 or less. The formed body of the present invention is preferably obtained by using the far infrared ray transmitting composition of the present invention described above.

The average primary particle diameter of the high refractive index particle included in the formed body of the present invention is preferably 100 μm or less and more preferably 50 μm or less. For example, the lower limit can be 0.001 μm or more and can be 0.01 μm or more. Details of the high refractive index particle are the same as the range described in the far infrared ray transmitting composition described above, and the preferable range is also the same.

The formed body of the present invention may further include an organic material, in addition to the above particle. Examples of the organic material include materials described in the far infrared ray transmitting composition described above. Examples thereof include an organic material (for example, a cured product of a curable compound) and a resin derived from a curable compound.

With respect to the formed body of the present invention, the average refractive index is preferably 1.3 to 5.0 in the wavelength range of 8 to 14 μm. The lower limit is preferably 1.35 or more and more preferably 1.4 or more. The upper limit is preferably 4.5 or less and more preferably 4.0 or less.

With respect to the formed body of the present invention, the refractive index at the wavelength of 10 μm is preferably 1.3 to 5.0. The lower limit is preferably 1.35 or more and more preferably 1.4 or more. The upper limit is preferably 4.5 or less and more preferably 4.0 or less.

With respect to the formed body of the present invention, the refractive index is preferably 1.3 to 5.0 in all of the wavelength range of 8 to 14 μm. The lower limit is preferably 1.35 or more and more preferably 1.4 or more. The upper limit is preferably 4.5 or less and more preferably 4.0 or less.

The refractive index and the average refractive index of the formed body are values measured by using IR-VASE manufactured by J. A. Woollam Co. An average value of the refractive index in the wavelength range of 8 to 14 μm of the measured sample is set as the average refractive index.

With respect to the formed body of the present invention, the average transmittance in the wavelength range of 8 to 14 μm is preferably 40 to 99%. The lower limit is preferably 45% or more and more preferably 50% or more. The upper limit is preferably 97% or less and more preferably 95% or less.

The transmittance of the formed body of the present invention at the wavelength of 10 μm is preferably 40% to 99%. The lower limit is preferably 45% or more and more preferably 50% or more. The upper limit is preferably 97% or less and more preferably 95% or less.

With respect to the formed body of the present invention, the average transmittance at the wavelength range of 8 to 14 μm is preferably 40% to 99%. The lower limit is preferably 45% or more and more preferably 50% or more. The upper limit is preferably 97% or less and more preferably 95% or less.

The transmittance and the average transmittance of the formed body are values measured by using NICOLET6700FT-IR (manufactured by Thermo Fisher Scientific Solutions LLC). The average value of the transmittance of the measurement sample at the wavelength range of 8 to 14 μm is the average transmittance.

The shape of the formed body of the present invention is not particularly limited. The shape thereof can be appropriately adjusted depending on the applications. Examples thereof include a film shape, a plate shape, or a lens shape. In a case of a film-shaped formed body, the thickness is preferably 0.1 to 5.0 μm, more preferably 0.2 to 4.0 μm, and even more preferably 0.3 to 3.0 μm. In a case of a plate-shaped formed body, the thickness is preferably 100 to 10,000 μm, more preferably 200 to 8,000 μm, and even more preferably 500 to 5,000 μm. The lens-shaped formed body may be a concave lens or a convex lens. The thickness of the lens can be appropriately adjusted.

The film-shaped formed body can be manufactured by a step of forming the composition layer by applying a composition (preferably a far infrared ray transmitting composition of the present invention) including a particle (high refractive index particle) having a refractive index of 1.3 to 5.0 at a wavelength of 10 μm and a medium to a substrate, to form a layer. If necessary, the step of drying the composition layer, the step of curing the composition layer, the step of forming a pattern on the composition layer, and the like may be performed. According to the present invention, it is preferable to have at least one of the step of drying the composition layer and the step of curing the composition layer.

The formed body may be used by being peeled off from the substrate or may be used in the state of being laminated on the substrate.

In the step of forming the composition layer, as a method of applying the composition to the substrate, well-known methods can be used. Examples thereof include a dropwise adding method (drop cast); a slit coating method; a spray method; a roll coating method; a spin coating method (spin coating); a casting coating method; a slit and spin method; a pre-wet method (for example, a method disclosed in JP2009-145395A); various printing methods such as inkjet (for example, an on-demand method, a piezo method, and a thermal method), ejection system printing such as nozzle jet, flexo printing, screen printing, gravure printing, inverse offset printing, and a metal mask printing method; a transfer method using a die or the like; and a nanoimprint method. The application method by inkjet is not particularly limited, and examples thereof include methods disclosed in “Spreading and usable inkjet—infinite possibilities in patent, issued in February 2005, S. B. Research Co., Ltd.” (particularly, pages 115 to 133), JP2003-262716A, JP2003-185831A, JP2003-261827A, JP2012-126830A, and JP2006-169325A.

In the step of drying the composition layer, the drying condition can be appropriately adjusted depending on the type and content of the medium included in the composition layer. For example, the temperature of 60° C. to 150° C. and 30 seconds to 15 minutes are preferable.

In the step of curing the composition layer, the curing treatment is not particularly limited, and can be appropriately selected depending on the purpose. For example, an exposure treatment and a heat treatment are suitably exemplified.

As the radiation (light) that can be used for the exposure treatment, ultraviolet rays such as g rays and i rays are preferably used (particularly preferably i rays). The irradiation amount (exposure amount) is, for example, preferably 0.03 to 2.5 J/cm² and more preferably 0.05 to 1.0 J/cm².

The oxygen concentration in a case of exposure can be appropriately selected. In addition to performing the exposure in the atmosphere, exposure is performed under a low oxygen atmosphere (for example, preferably 15 vol % or less, more preferably 5 vol % or less, and even more preferably oxygen free) having an oxygen concentration of 19 vol % or less, or exposure may be performed under a high oxygen atmosphere (for example, preferably 22 vol % or more, more preferably 30 vol % or more, and even more preferably substantially 50 vol % or more) in which the oxygen concentration exceeds 21 vol %. The exposure illuminance can be appropriately set, and generally can be selected in the range of 1,000 W/m² to 100,000 W/m² (for example, preferably 5,000 W/m² or more, more preferably 15,000 W/m² or more, and even more preferably 35,000 W/m²). The conditions of the oxygen concentration and the expose illuminance can be appropriately combined, and for example, at the oxygen concentration can be set as 10 vol %, the illuminance can be set as 10,000 W/m², or the oxygen concentration can be set as 35 vol %, the illuminance can be set as 20,000 W/m².

The heating temperature in the heat treatment is preferably 100° C. to 260° C. The lower limit is preferably 120° C. or more and more preferably 160° C. or more. The upper limit is preferably 240° C. or less and more preferably 220° C. or less. The heating time is preferably 1 to 180 minutes. The lower limit is preferably 3 minutes or more. The upper limit is preferably 120 minutes or less. The heating device is not particularly limited, and can be appropriately selected depending on the purpose. Examples thereof include a dry oven, a hot plate, and an infrared heater.

In the step of forming the pattern, a pattern may be formed in the composition layer by photolithography, or a pattern may be formed in the composition layer by a dry etching method.

In a case where a pattern is formed on the composition layer by photolithography, examples thereof include a method of a step of applying the composition (preferably, the far infrared ray transmitting composition of the present invention) including a particle (high refractive index particle) having a refractive index of 1.3 to 5.0 at a wavelength of 10 μm and a medium to a substrate to form the composition layer, a step of exposing the composition layer in a pattern form, and a step of developing and removing the unexposed portion to form a pattern. In a case of the pattern forming by using photolithography, it is preferable that the composition preferably includes a polymerizable compound, a photopolymerization initiator, and an alkali-soluble resin.

The step of forming the composition layer can be performed by using the above method.

Examples of the step of exposing the composition layer in a pattern shape include a method of exposing the composition layer on the substrate by using an exposure device such as a stepper via a mask having a predetermined mask pattern. Accordingly, the exposed portion can be cured.

In the step of developing and removing the unexposed portion, developing and removing the unexposed portion can be performed by using a developer. As a result, the composition layer in the unexposed portion elutes into the developer, and only the photocured portion remains. As a developer, an alkali developer which does not cause damage to the underlying circuit and the like is desirable. For example, the temperature of the developer is preferably 20° C. to 30° C. The development time is preferably 20 to 180 seconds and more preferably 20 to 90 seconds.

As the alkali developer, for example, inorganic alkali such as sodium hydroxide, potassium hydroxide, sodium carbonate, sodium silicate, sodium metasilicate, and ammonia water, primary amines such as ethyl amine and N-propyl amine, secondary amines such as diethyl amine and di-n-butyl amine, tertiary amines such as triethyl amine and methyl diethyl amine, alcohol amines such as dimethylethanol amine and triethanol amine, tetraalkyl ammonium hydroxide such as dimethylbis (2-hydroxyethyl) ammonium hydroxide, tetramethylammonium hydroxide, tetraethyl ammonium hydroxide, tetrapropylammonium hydroxide, tetrabutyl ammonium hydroxide, tetrapentylammonium hydroxide, tetrahexylammonium hydroxide, tetraoctylammonium hydroxide, ethyl trimethyl ammonium hydroxide, butyl trimethyl ammonium hydroxide, methyl triamyl ammonium hydroxide, and dibutyl dipentyl ammonium hydroxide, quaternary ammonium salt such as trimethylphenyl ammonium hydroxide, trimethylbenzyl ammonium hydroxide, and triethylbenzylammonium hydroxide, an alkaline aqueous solution including an alkaline agent such as cyclic amines such as pyrrole and piperidine can be used. Alcohols and a surfactant may be added to the alkaline aqueous solution in an appropriate amount for use. The alkali agent concentration of the alkali developer is preferably 0.001 to 20 mass %, more preferably 0.01 to 10 mass %, and even more preferably 0.1 to 1 mass %. The pH of the alkali developer is preferably 10.0 to 14.0. The alkali agent concentration and the pH of the alkali developer can be appropriately adjusted and used. For example, an appropriate amount of a water-soluble organic solvent such as methanol or ethanol, a surfactant, or the like may be added and used as the alkali developer.

After the development, heating or exposure may be further performed. According to this aspect, the curing of the film further proceeds, and a more firmly cured film can be manufactured.

The plate-shaped or lens-shaped formed body can be manufactured by using a composition (preferably a far infrared ray transmitting composition of the present invention) including a particle (high refractive index particle) having a refractive index of 1.3 to 5.0 at a wavelength of 10 μm and a medium by a well-known ceramic manufacturing method. Specific examples thereof include a die press forming method, a rubber pressing method, an injection forming method, a slip casting method, and an extrusion forming method. Forming conditions can be suitably adjusted depending on the kind of medium and application.

The formed body of the present invention can be preferably used as a formed body for a far infrared ray transmitting filter. Specifically, the formed body can be preferably used for a far infrared ray transmitting filter used for inspection equipment and a sensor using far infrared rays, a far infrared ray transmitting filter used for a sensor using far infrared rays such as a current collecting sensor, and a substrate material for measuring far infrared transmittance. The formed body can also be used by being incorporated into an infrared camera or a solid-state imaging device for use.

<Laminate>

Subsequently, the laminate of the present invention is described. The laminate of the present invention has a substrate and the formed body of the present invention provided on the substrate.

The substrate used in the laminate is preferably a Ge substrate, an Si substrate, a ZnSe substrate, a ZnS substrate, a CaF₂ substrate, an ITO substrate, an Al₂O₃ substrate, a BaF₂ substrate, a chalcogenide glass substrate, a diamond substrate, a quartz substrate, an MgF₂ substrate, and an LiF substrate, more preferably a Ge substrate, a Si substrate, a chalcogenide glass substrate, a ZnS substrate, and a ZnSe substrate, and even more preferably a Ge substrate. By using these substrates, a laminate having excellent far infrared ray transmitting properties is easily obtained. A functional layer such as an antireflection layer, a hard coat layer, or a barrier layer may be formed on the substrate used for the laminate.

With respect to the laminate of the present invention, a refractive index n1 of the formed body at a wavelength of 10 μm and a refractive index n2 of the layer (hereinafter, also referred to as another layer) that is in contact with the formed body in a thickness direction of the formed body at a wavelength of 10 μm preferably satisfies the following relationship.

(n2)^{0.5}−1≤n1≤(n2)^{0.5}+1

The refractive index n1 and the refractive index n2 more preferably satisfy the following relationship.

(n2)^{0.5}−0.5≤n1≤(n2)^{0.5}+0.5

The refractive index n1 and the refractive index n2 even more preferably satisfy the following relationship.

(n2)^{0.5}−0.1≤n1≤(n2)^{0.5}+0.1

In a case where the refractive index n1 and the refractive index n2 satisfy the following relationship, it is possible to obtain a laminate having excellent far infrared ray transmitting properties and excellent antireflection properties.

In a case where the formed body of the present invention is directly laminated on the substrate on which a functional layer is not formed, the substrate corresponds to another layer. In a case where the formed body of the present invention is laminated on the substrate on which a functional layer is formed (that is, the functional layer is interposed between the substrate and the formed body of the present invention), the functional layer (the functional layer immediately below the formed body of the present invention) that is in contact with the formed body of the present invention corresponds to another layer.

With respect to the laminate of the present invention, a product of the refractive index n1 at a wavelength of 10 μm and a thickness T (the unit is μm) of the formed body preferably satisfies the following relationship.

1.5<T·n1<3.5

The product of the refractive index n1 and the thickness T of the formed body more preferably satisfies the following relationship.

2.0<T·n1<3.0

The product of the refractive index n1 and the thickness T of the formed body even more preferably satisfies the following relationship.

2.2<T·n1<2.7

In a case where the product of the refractive index n1 and the thickness T of the formed body satisfies the above relationship, a laminate having excellent far infrared ray transmitting properties and excellent antireflection properties can be obtained.

The laminate of the present invention can be preferably used in the far infrared ray transmitting filter that transmits far infrared ray in the wavelength range of 1 to 14 μm (preferably in the wavelength range of 3 to 5 μm or 8 to 14 μm). Specifically, the laminate can be preferably used for a far infrared ray transmitting filter used for inspection equipment and a sensor using far infrared rays, a far infrared ray transmitting filter used for a sensor using far infrared rays such as a current collecting sensor, and a substrate material for measuring far infrared transmittance. The laminate can be incorporated into an infrared camera or a solid-state imaging device for use.

<Far Infrared Ray Transmitting Filter>

The far infrared ray transmitting filter of the present invention has the formed body of the present invention or the laminate of the present invention.

The far infrared ray transmitting filter of the present invention preferably has an average refractive index in the wavelength range of 8 to 14 μm is 1.3 to 5.0. The lower limit is preferably 1.35 or more and more preferably 1.4 or more. The upper limit is preferably 4.5 or less and more preferably 4.0 or less.

The far infrared ray transmitting filter of the present invention is preferably a refractive index of 1.3 to 5.0 at a wavelength of 10 μm. The lower limit is preferably 1.35 or more and more preferably 1.4 or more. The upper limit is preferably 4.5 or less and more preferably 4.0 or less.

The far infrared ray transmitting filter of the present invention preferably has a refractive index of 1.3 to 5.0 in all the wavelength range of 8 to 14 μm. The lower limit is preferably 1.35 or more and more preferably 1.4 or more. The upper limit is preferably 4.5 or less and more preferably 4.0 or less.

The far infrared ray transmitting filter of the present invention preferably has an average transmittance of 40 to 99% in the wavelength range of 8 to 14 μm. The lower limit is preferably 45% or more and more preferably 50% or more. The upper limit is preferably 97% or less and more preferably 95% or less.

The transmittance of the far infrared ray transmitting filter of the present invention at a wavelength of 10 μm is preferably 40 to 99%. The lower limit is preferably 45% or more and more preferably 50% or more. The upper limit is preferably 97% or less and more preferably 95% or less.

In all the wavelength range of 8 to 14 μm of the far infrared ray transmitting filter of the present invention, the average transmittance is preferably 40% to 99%. The lower limit is preferably 45% or more and more preferably 50% or more. The upper limit is preferably 97% or less and more preferably 95% or less.

The far infrared ray transmitting filter of the present invention can be preferably used for inspection equipment and a sensor using far infrared rays. Examples thereof include a gas detection sensor, a human body detection sensor, a non-destructive inspection sensor, a distance measuring sensor, a biometric sensor, a motion capture sensor, a temperature measurement sensor, a component analysis sensor, and a vehicle sensor.

<Solid-State Imaging Device and Infrared Camera>

The solid-state imaging device of the present invention has a far infrared ray transmitting filter of the present invention. The infrared camera of the present invention has the far infrared ray transmitting filter of the present invention. The configuration of the solid-state imaging device and infrared camera has the configuration of the far infrared ray transmitting filter of the present invention, and the configuration is not particularly limited, as long as the configuration functions as a solid-state imaging device and an infrared camera.

Examples of the solid-state imaging device include the following configuration.

A plurality of photodiodes that form a light receiving area of a solid-state imaging device and a transfer electrode made of polysilicon or the like are provided on a substrate, a photodiode and a light shielding film which is made of tungsten or the like and in which only a light receiving section of the photodiode on the transfer electrode is open are provided, a device protective film which is formed to cover the entire surface of the light shielding film and the photodiode light receiving section are provided on the light shielding film and which is made of silicon nitride or the like, and the cured film of the present invention is provided on the device protective film. In the solid-state imaging device, the color filter may have a structure in which a cured film forming each color pixel is embedded, for example, in a space partitioned in a lattice shape by a partition wall. In this case, it is preferable that the partition wall has a low refractive index with respect to each color pixel. Examples of the image pick-up device having such a structure include devices disclosed in JP2012-227478A and JP2014-179577A.

### EXAMPLES

Hereinafter, the present invention is specifically described with reference to the examples. A material, an amount used, a treatment detail, a treatment order, and the like provided in the following examples can be suitably changed without departing from the gist of the present invention. Accordingly, the range of the present invention is not limited to the specific examples described below. Unless described otherwise, “%” and “parts” are based on mass.

<Method of Measuring Acid Value>

A measurement sample was dissolved in a mixed solvent of tetrahydrofuran/water=9/1 (mass ratio), and the solution obtained by using a potentiometric titrator (trade name: AT-510, manufactured by Kyoto Electronics Manufacturing Co., Ltd.) was subjected to neutralization titration with a 0.1 mol/L sodium hydroxide aqueous solution at 25° C. An acid value was calculated by using an inflection point of a titration pH curve as a titration end point by the following equation.

A=56.11×Vs×0.5×f/w

A: Acid value (mgKOH/g)

Vs: Used amount of 0.1 mol/L sodium hydroxide aqueous solution used for titration (mL)

f: Titer of 0.1 mol/L sodium hydroxide aqueous solution

w: measurement sample mass (g) (expressed in terms of solid content)

<Method of Measuring Weight-Average Molecular Weight>

In the measuring of the weight-average molecular weight, HPC-8220GPC (manufactured by Tosoh Corporation) was used as a measuring device, TSK guard column Super HZ-L was used as a guard column, a column obtained by directly connecting TSKgel Super HZM-M, TSKgel Super HZ4000, TSKgel Super HZ3000, and TSKgel Super HZ2000 was used as a column, a column temperature was set as 40° C., 10 μL of a tetrahydrofuran solution having a sample concentration of 0.1 mass % was injected, tetrahydrofuran was flowed at a flow rate of 0.35 mL/min as an elution solvent, a sample peak was detected with a differential refractive index (RI) detector, and a calibration curve manufactured by using standard polystyrene was used for calculation.

<Refractive Index of Particle>

With respect to the refractive index of the particle, for a material of which a bulk crystal numerical value was known, the known numerical value was used, and for the material of which a bulk crystal numerical value was unknown, a vapor deposition film of a compound forming a measurement target particle was formed, and a value measured by IR-VASE manufactured by J. A. Woollam Co. was used.

### Test Example 1

<Preparation of Dispersion Liquid 1>

Dispersion Liquid 1 was obtained by performing a dispersion treatment on a mixed liquid having the following composition by using ULTRA APEX MILL manufactured by Hiroshima Metal & Machinery Co., Ltd. as a recycling dispersion apparatus (beads mill).

(Composition of Mixed Liquid)

Particle: Indium tin oxide (ITO) particle (manufactured by Mitsubishi Materials Corporation, P4-ITO, refractive index of 2.8 at wavelength of 10 μm, average primary particle diameter of 20 nm) . . . 18 parts

Resin: Resin A (Solid content: 30%, Solvent: propylene glycol monomethyl ether) . . . 6.7 parts
Organic solvent: Cyclohexanone . . . 75.3 parts

The dispersion apparatus was operated under the following conditions.
Bead diameter: diameter of 0.05 mm
Bead packing ratio: 75 vol %
Circumferential speed: 10 m/s
Supply amount of pump: 10 kg/hour
Cooling water: Tap water
Inner volume of beads mill cyclic passage: 0.15 L
Amount of mixed liquid subjected to dispersion treatment: 0.7 kg

Resin A: Resin of the following structure (In the formula, n was 14, the weight-average molecular weight was 6,400, and the acid value was 80 mgKOH/g. The resin A was synthesized in conformity with a synthesis method disclosed in paragraphs 0114 to 0140 and 0266 to 0348 of JP2007-277514A.)

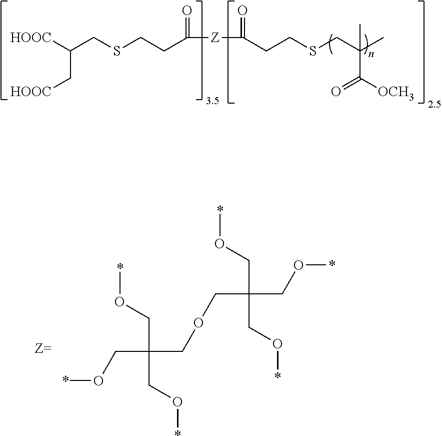

<Preparation of Dispersion Liquid 2>

Dispersion Liquid 2 was prepared in the same manner as Dispersion Liquid 1 except that the following mixed liquid was used.

(Composition of Mixed Liquid)

| | | |
|---|---|---|
| Particle: Ge particle (refractive index of 4.0 at wavelength of 10 μm, average | 18 | parts |
| primary particle diameter: 50 nm) | | |
| Resin: Resin B (Solid content: 30%, Solvent: propylene glycol monomethyl ether) | 6.7 | parts |
| Organic solvent: Propylene glycol methyl ether acetate | 75.3 | parts |

Resin B: Resin having the following structure (weight-average molecular weight
of 24,000, acid value of 53 mgKOH/g)

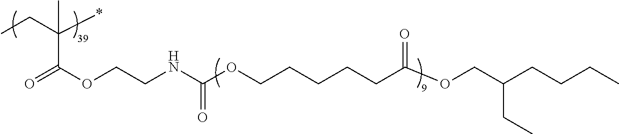

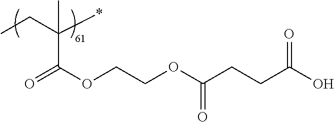

<Preparation of Dispersion Liquids 3 to 13>

Dispersion liquids were prepared in the same manner as Dispersion Liquid 1 except that types of particles and resins were changed as below.

TABLE 1

| | Particle | | |
|---|---|---|---|
| Dispersion Liquid | Type | Refractive index of particle | Resin |
| 3 | ITO | 2.8 | Resin C |
| 4 | Ge | 4.0 | Resin C |
| 5 | GeO₂ | 1.7 | Resin C |
| 6 | Si | 3.4 | Resin C |
| 7 | ZnSe | 2.4 | Resin C |
| 8 | ZnS | 2.6 | Resin C |
| 9 | CaF₂ | 1.3 | Resin C |
| 10 | MgF₂ | 1.4 | Resin C |
| 11 | Ge | 4.0 | Resin D |
| 12 | Ge | 4.0 | Resin E |
| 13 | Ge | 4.0 | Resin F |

Values of refractive indexes of particles presented in the table were values of refractive indexes at a wavelength of 10 μm.

The average primary particle diameter of the ITO particle was 20 nm.

The average primary particle diameter of the GeO₂ particle was 50 nm.

The average primary particle diameter of the Si particle was 50 nm.

The average primary particle diameter of the ZnSe particle was 50 nm.

The average primary particle diameter of the ZnS particle was 50 nm.

The average primary particle diameter of the CaF₂ particle was 50 nm.

The average primary particle diameter of the MgF₂ particle was 50 nm.

As Resin C, DISPERBYK 103 (manufactured by BYK Chemie GmbH) was used.

As Resin D, a 30 mass % propylene glycol methyl ether acetate solution of a resin having the following structure was used. The weight-average molecular weight of a resin having the following structure was 23,000. Numerical value appended to the repeating unit were molar ratios.

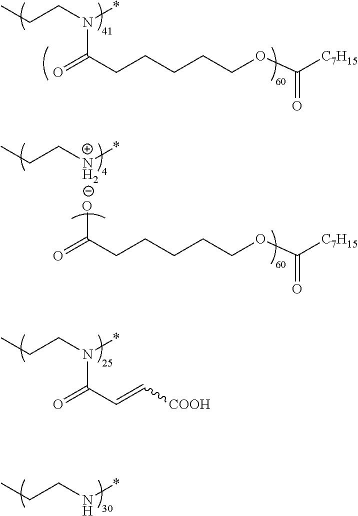

As Resin E, DISPERBYK 111 (manufactured by BYK Chemie GmbH) was used.

As Resin F, a 44 mass % propylene glycol methyl ether acetate solution of a resin having the following structure was used. The weight-average molecular weight of a resin having the following structure was 40,000. Numerical value appended to the repeating unit was a molar ratio.

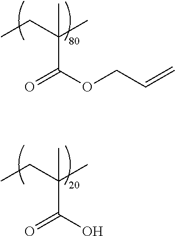

<Preparing of Composition>

### Example 1

The following components were mixed so as to prepare a composition of Example 1.

| | | |
|---|---|---|
| Dispersion Liquid 1 | 22.5 | parts |
| Alkali-soluble Resin 1 (44 mass % propylene glycol | 34.3 | parts |

methyl ether acetate solution of the resin having the
following structure. The weight-average molecular
weight of the resin having the following structure
was 5,000. A numerical value appended to the
repeating unit was a molar ratio.)

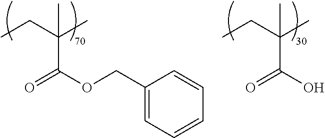

| | | |
|---|---|---|
| Polymerizable compound (ARONIX M-510, | 10.9 | parts |
| manufactured by Toagosei Co., Ltd.) | | |
| Photopolymerization initiator (IRGACURE | 3.2 | parts |
| OXE01, manufactured by BASF SE) | | |
| Surfactant 1 below (Mixed product below, | 0.04 | parts |
| weight-average molecular weight = 14,000, % | | |
| indicating proportion of repeating unit was mass %) | | |

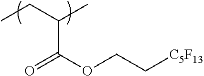

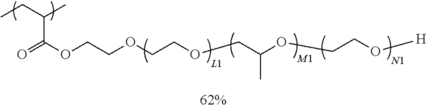

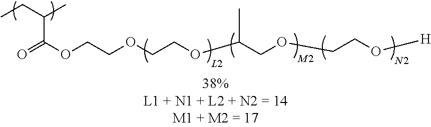

| | | |
|---|---|---|
| Polymerization inhibitor (p-methoxy phenol) | 0.005 | parts |
| Ultraviolet absorbing agent (UV-503, | 0.4 | parts |
| manufactured by Daito Chemical Co., Ltd.) | | |
| Silane coupling agent (KBM-502, manufactured by | 0.2 | parts |
| Shin-Etsu Chemical Co., Ltd.) | | |
| Organic solvent 1 (PGMEA) | 28.4 | parts |

### Examples 2 to 13

The compositions were prepared in the same manner as in Example 1 except that Dispersion Liquid 1 in Example 1 was changed to Dispersion Liquids 2 to 13.

### Example 14

The composition was prepared in the same manner as in Example 1 except that 11.25 parts of Dispersion Liquid 1 and 11.25 parts of Dispersion Liquid 2 were used instead 22.5 parts of Dispersion Liquid 1 in Example 1.

### Example 15

The composition was prepared in the same manner as in Example 2 except that 17.15 parts of Alkali-soluble Resin 1 in Example 2 was changed to 17.15 parts of Resin F.

### Example 16

The composition was prepared in the same manner as in Example 2 except that the polymerizable compound in Example 2 was changed to 5.45 parts of ARONIX M-510 (manufactured by Toagosei Co., Ltd.) and 5.45 parts of KAYARAD DPHA (manufactured by Nippon Kayaku Co., Ltd.).

### Example 17

The composition was prepared in the same manner as in Example 2 except that the photopolymerization initiator in Example 2 was changed to 1.2 parts of IRGACURE OXE01 (manufactured by BASF SE), 1.0 parts of IRGACURE OXE03 (manufactured by BASF SE), and 1.0 parts of IRGACURE 369 (manufactured by BASF SE).

### Example 18

The composition was prepared in the same manner as in Example 2 except that the alkali-soluble resin in Example 2 was changed to 10.15 parts of Alkali-soluble Resin 1 and 7.0 parts of Resin F.

<Manufacturing of Formed Body>

Each composition was spin-coated on a Si wafer such that the film thickness after the heat treatment became 1.35 μm and was dried at 100° C. for 120 seconds by using a hot plate, then a heat treatment was performed at 200° C. for 300 seconds, so as to manufacture a formed body.

<Measuring of Refractive Index of Formed Body>

The composition to be measured was coated on a Si wafer and heat-treated at 200° C. for 5 minutes to form a formed body so as to manufacture a measurement sample. The refractive index of the manufactured measurement sample at a wavelength of 1.7 to 30 μm was measured by using IR-VASE manufactured by J. A. Woollam Co.

<Measuring of Far Infrared Ray Transmittance of Formed Body>

The far infrared ray transmittance of the formed body manufactured by the above method was measured by using NICOLET6700FT-IR (manufactured by Thermo Fisher Scientific Solutions LLC). As the reference, a Si wafer used as a substrate was used. The results are summarized in Table 2.

A case where the transmittance of light at a wavelength of 10 μm was 90% or more was evaluated as 5, a case where the transmittance of light at a wavelength of 10 μm was less than 90% and 80% or more was evaluated as 4, a case where the transmittance of light at a wavelength of 10 μm was less than 80% and 70% or more was evaluated as 3, a case where the transmittance of light at a wavelength of 10 μm was less than 70% and 60% or more was evaluated as 2, and a case where the transmittance of light at a wavelength of 10 μm was less than 60% was evaluated as 1.

TABLE 2

| | | | Far infrared ray |
|---|---|---|---|
| | | | transmittance |
| | | | of formed body |
| | | Refractive index of formed | at wavelength |
| | Particle | body at wavelength of 10 μm | of 10 μm |
| Example 1 | ITO | 1.85 | 3 |
| Example 2 | Ge | 2.08 | 5 |
| Example 3 | ITO | 1.85 | 3 |
| Example 4 | Ge | 2.08 | 5 |
| Example 5 | GeO₂ | 1.62 | 3 |
| Example 6 | Si | 1.96 | 4 |
| Example 7 | ZnSe | 1.76 | 5 |
| Example 8 | ZnS | 1.8 | 5 |
| Example 9 | CaF₂ | 1.31 | 2 |
| Example 10 | MgF₂ | 1.47 | 2 |
| Example 11 | Ge | 2.08 | 5 |
| Example 12 | Ge | 2.08 | 5 |
| Example 13 | Ge | 2.08 | 5 |
| Example 14 | Ge, ITO | 1.97 | 2 |
| Example 15 | Ge | 2.08 | 5 |
| Example 16 | Ge | 2.08 | 5 |
| Example 17 | Ge | 2.08 | 5 |
| Example 18 | Ge | 2.08 | 5 |

As described in the above table, in the examples, it was able to manufacture a formed body having a high far infrared ray transmittance.

### Test Example 2

### Example 101

The composition of Example 1 above was spin-coated on a Si wafer such that the film thickness after the heat treatment became 1.35 μm and dried at 100° C. for 120 seconds by using a hot plate, and then a heat treatment was further performed at 200° C. for 300 seconds, so as to manufacture a formed body. The refractive index of the formed body at a wavelength of 10 μm was 1.85, and the refractive index of the Si wafer at a wavelength of 10 μm was 3.42.

With respect to the Si wafer on which the above formed body was laminated, the transmittance of light with a wavelength of 10 μm of the Si wafer was measured by using NICOLET 6700 FT-IR (manufactured by Thermo Fisher Scientific Solutions LLC). The transmittance of the laminate including the Si wafer was measured by performing the reference measurement without the Si wafer.

### Example 102

The composition of Example 2 above was spin-coated on a Ge wafer such that the film thickness after the heat treatment became 1.25 μm and dried at 100° C. for 120 seconds by using a hot plate, and then a heat treatment was further performed at 200° C. for 300 seconds, so as to manufacture a formed body. The refractive index of the formed body at a wavelength of 10 μm was 2.08, and the refractive index of the Ge wafer at the wavelength of 10 μm was 4.0.

With respect to the Ge wafer on which the formed body was laminated, the transmittance of light at the wavelength 10 μm was measured by using NICOLET 6700 FT-IR (manufactured by Thermo Fisher Scientific Solutions LLC). The transmittance of the substrate including the Ge substrate was measured by performing the reference measurement without the Ge substrate.

### Comparative Example 101

The transmittance of the Si wafer of light at the wavelength 10 μm was measured by using NICOLET 6700 FT-IR (manufactured by Thermo Fisher Scientific Solutions LLC). The transmittance of the substrate was measured by performing the reference measurement without a substrate.

### Comparative Example 102

The transmittance of the Ge wafer of light at the wavelength 10 μm was measured by using NICOLET 6700 FT-IR (manufactured by Thermo Fisher Scientific Solutions LLC). The transmittance of the substrate was measured by performing the reference measurement without a substrate.

TABLE 3

| | | | Film | |
|---|---|---|---|---|
| | | | thickness of | |
| | Type of | Refractive index | formed body | |
| Level | wafer | of formed body | (μm) | Transmittance |
| Example 101 | Si | 1.85 | 1.35 | 90% |
| Example 102 | Ge | 2.08 | 1.25 | 95% |
| Comparative | Si | — | — | 48% |
| Example 101 | | | | |
| Comparative | Ge | — | — | 47% |
| Example 102 | | | | |

According to the above results, the transmittances of the examples of light at a wavelength of 10 μm were higher than those of comparative examples, and far infrared ray transmitting properties were excellent.

### Test Example 3

### Example 201

A flat sheet-shaped formed body was manufactured by injection-forming Dispersion Liquid 2. The refractive index of the formed body at a wavelength of 10 μm was 3.8. The transmittance of light at a wavelength of 10 μm was 60%.

### Example 202

A flat sheet-shaped formed body was manufactured in the same manner as in Example 201 except that the liquid used was changed to the composition of Example 2. The refractive index of the formed body at a wavelength of 10 μm was 2.1. The transmittance of the light at a wavelength of 10 μm was 70%.

What is claimed is:

1. A far infrared ray transmitting composition comprising:
a particle having refractive index of 1.3 to 5.0 at a wavelength of 10 μm; and
a medium.

2. The far infrared ray transmitting composition according to claim 1,
wherein 15 mass % or more of the particle is contained with respect to a total solid content of the far infrared ray transmitting composition.

3. The far infrared ray transmitting composition according to claim 1,
wherein the medium includes at least one selected from a resin, a curable compound, and a solvent.

4. The far infrared ray transmitting composition according to claim 1,
wherein the particle is an inorganic particle including at least one atom selected from Ge, Zn, Si, and F.

5. The far infrared ray transmitting composition according to claim 2,
wherein the particle is an inorganic particle including at least one atom selected from Ge, Zn, Si, and F.

6. The far infrared ray transmitting composition according to claim 3,
wherein the particle is an inorganic particle including at least one atom selected from Ge, Zn, Si, and F.

7. A formed body comprising:
a particle having a refractive index of 1.3 to 5.0 at a wavelength of 10 μm.

8. The formed body according to claim 7,
wherein an average refractive index in a wavelength range of 8 to 14 μm is 1.3 to 5.0.

9. The formed body according to claim 7,
wherein a shape of the formed body is a film shape, a flat sheet shape, or a lens shape.

10. The formed body according to claim 7,
wherein the particle is an inorganic particle including at least one atom selected from Ge, Zn, Si, and F.

11. The formed body according to claim 7, which is used for a far infrared ray transmitting filter.

12. A laminate comprising:
a substrate; and
the formed body according to claim 7, which is provided on the substrate.

13. The laminate according to claim 12,
wherein a refractive index n1 of the formed body at a wavelength of 10 μm and a refractive index n2 of a layer that is in contact with the formed body in a thickness direction of the formed body at a wavelength of 10 μm satisfy the following relationship.
(n2)^{0.5}−1≤n1≤(n2)^{0.5}+1

14. The laminate according to claim 12,
wherein a product of a refractive index n1 of the formed body at a wavelength of 10 μm and a thickness T of the formed body satisfies the following relationship:
1.5<T·n1<3.5,
where a unit of T is μm.

15. The laminate according to claim 12, which is used for a far infrared ray transmitting filter.

16. The laminate according to claim 15,
wherein the substrate is a Ge substrate, a chalcogenide glass substrate, a ZnS substrate, or a ZnSe substrate.

17. A far infrared ray transmitting filter comprising:
the formed body according to claim 7.

18. A far infrared ray transmitting filter comprising:
the laminate according to claim 12.

19. A solid-state imaging device comprising:
the far infrared ray transmitting filter according to claim 17.

20. An infrared camera comprising:
the far infrared ray transmitting filter according to claim 17.
